(19) United States
(12) Patent Application Publication
(10) Pub. No.: US 2021/0251125 A1
(43) Pub. Date: Aug. 19, 2021

(54) SUB-SOIL STRIP TILL POINT

(71) Applicant: Orthman Manufacturing, Inc., Lexington, NE (US)

(72) Inventor: Grant Roepsch, Lexington, NE (US)

(21) Appl. No.: 17/249,019

(22) Filed: Feb. 17, 2021

Related U.S. Application Data
(60) Provisional application No. 62/977,545, filed on Feb. 17, 2020.

(51) Int. Cl. A01B 15/02; A01B 3/24

(52) U.S. Cl. CPC A01B 15/025; A01C 7/08; A01B 3/24

(57) ABSTRACT

A ground-working tool including a shank and a sub-soil point at the bottom end of the shank. The sub-soil point has a leading cutting edge transverse to and in front of the longitudinal axis of the shank, a back portion behind the shank, a top portion from the leading edge to the shank, a bottom portion, and opposite lateral sides. A soil-rolling surface on at least one of the opposite lateral sides of the sub-soil point, each soil-rolling surface being concave in cross-section between top and bottom edges along a front to back length.

### CROSS-REFERENCE TO RELATED APPLICATIONS

This application claims the benefit of Provisional Application U.S. Ser. No. 62/977,545 filed on Feb. 17, 2020, all of which is herein incorporated by reference in its entirety.

### BACKGROUND OF THE INVENTION

### A. Field of the Invention

The present invention relates to ground-working tools and, in particular, to sub-soil tools. A beneficial application is strip till cultivation in agriculture. The tool includes a sub-soil point that rolls soil around opposite lateral sides of a shank as it moves at a selected depth in the soil to leave a uniform density soil in the wake of the point. In the application to strip till agricultural, it can work from depths of 1 inch to 11 inches.

### B. Related Art

A variety of sub-soil ground-working tools exist. They range from plows, to chisels, to rippers, to cultivators, to trenchers. As is well-known, driving such tools into the subsoil and then dragging them through the sub-soil, can encounter significant mechanical resistance. It can require significant motive power to overcome that resistance. Therefore, the tools must be robust. This is particularly true if the soil or sub-soil is dense, compacted, or otherwise hardened. Overcoming such resistance can result in modification of the sub-soil profile. Examples would be disruption, eruption, or otherwise moving extant layers to different locations. It can also result in leaving of voids, air pockets, or channels in the wake of the tool. This can be detrimental to seed germination and growth.

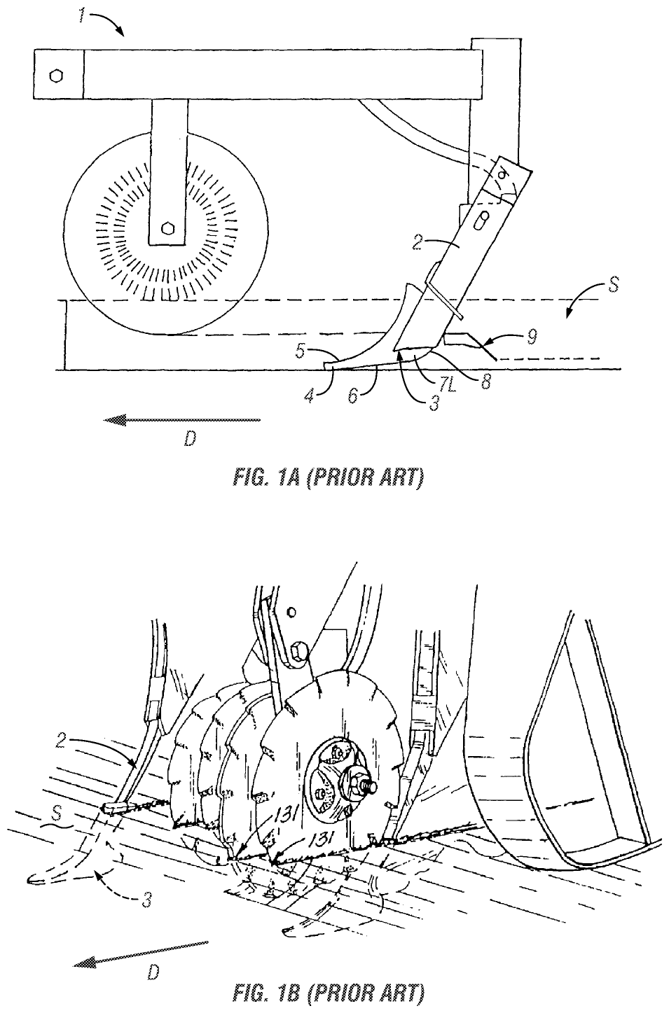

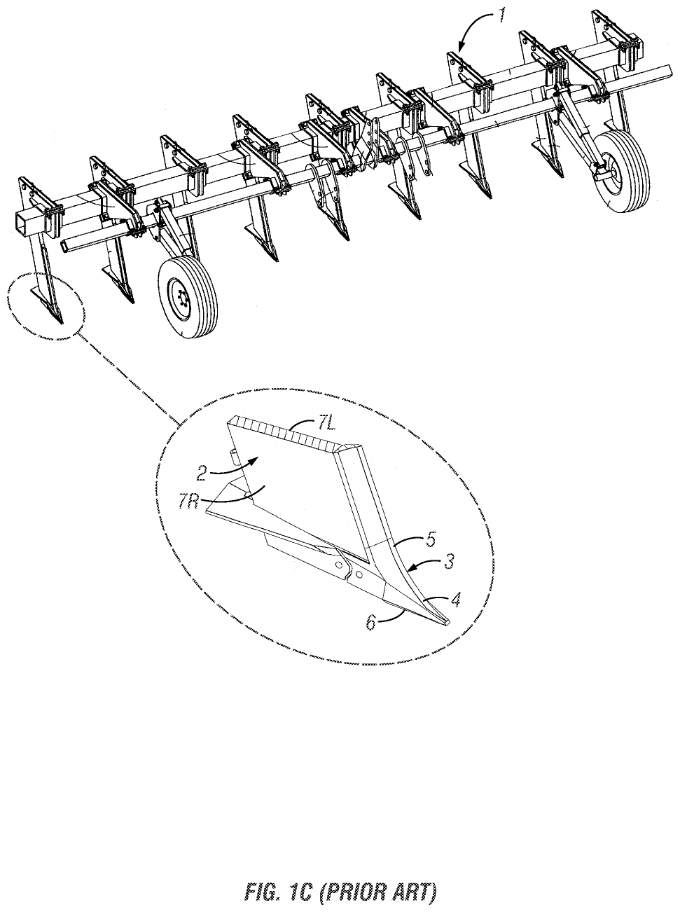

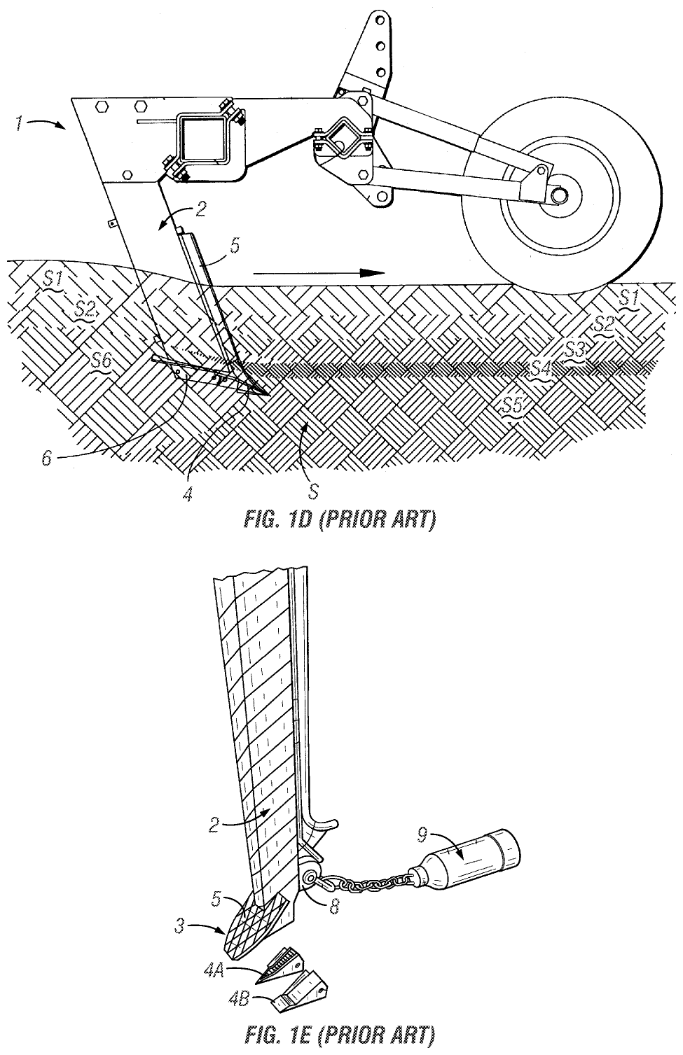

A variety of attempts have been made at providing different sub-soil ground-working tools. For example, U.S. Pat. No. 6,425,445 (see, e.g., FIG. 1A), incorporated by reference herein, describes a blade-like shank and sharp sub-soil point that slit the ground. The point extends forwardly of the shank blade in the general direction of travel to help penetrate the soil and guide the slitting blade. In this example, a trailing feature, called a mole 9, intentionally creates a trench with compressed sidewalls below the soil surface. U.S. Pat. No. 6,425,445 (see, e.g., FIG. 1B) is another example of a blade-like soil slitting shank with a sharp forward-pointing point.

These types of shank/point combinations slice through the soil but tend to leave a cavity behind the point that can inhibit plant growth. Plant growth is promoted by surrounding seed with nutrient-rich sub-soil.

U.S. Pat. No. 5,415,236 to Williams (see, e.g., FIGS. 1C-D) incorporated by reference herein, illustrates another soil slitting shank and relatively narrow forward pointing point. It is another example of a substantially vertical cutting blade shank to create a clean slit slice in the soil. A narrow but forward sub-soil point leads the structure. Planar wings extend laterally from the sides of the tip to guide the device through the soil and deter turbulence ahead of the shank which can cause the soil to erupt ahead of the shank to degrade the ground and create problems in planting. The lateral wings provide a laminar flow of soil over and around the wings. It recognizes the goal of leaving the soil relatively intact, but concentrates on relieving pressure on the soil that can build from resistance to the baled moving through the soil which can erupt the soil at its surface.

U.S. Pat. No. 10,100,491 (see, e.g., FIG. 1E) incorporated by reference herein, shows a blade shank with a wide inclined forward plate to which can be mounted interchangeable sharp points or tips. A mole or other device can be attached to and dragged behind the blade shank. This would intentionally create a channel with smeared walls in the sub-soil.

The inventor has recognized there is room for improvement in this technological area. In particular, the inventor has recognized that need for a solution to the problem of leaving cavities or air spaces in the subsoil by dragging the slitting shanks and points through the sub-soil. This can be a significant issue in minimum tillage situations. Minimum tillage minimizes the number of field passes and soil conditioning steps for planting, growing, and harvesting crops. After harvest, stubble and residue are left in place. The next planting typically involves one-pass slitting of the soil and insertion of seeds in the slits. Minimum tillage can present hard pan, crop residue, soil heaving, and other issues that present challenges to providing a receptive sub-soil seed bed for planting seeds and plant growth.

### SUMMARY OF THE INVENTION

### A. Objects, Features, and Advantages of the Invention

A primary object, feature, or advantage of the present invention is an apparatus, system, and method which improves over or solves problems and deficiencies in the state of the art.

Another object, feature or advantage of the present invention is an apparatus, system, or method which deters the formation of voids or air pockets in the sub-soil, including at seed planting depths after opening of the soil with a blade-type shank and sub-soiler point or tip.

Further objects, features, or advantages of the present invention is an apparatus, system, or method which, at least at the depth level of travel of the sub-soil point:
a. deters inconsistent compaction of the subsoil;
b. promotes more uniform soil density;
c. improves sub-soil seed beds for both planters and plant growth and health if used for crop production;
d. promotes uniformity of sub-soil seed beds across a field if used for crop production.

### B. Aspects of the Invention

One aspect of the invention is an apparatus comprising a ground-slitting vertical blade shank, a sub-soil point at the bottom of the shank, and soil-rolling side features of the sub-soil point to roll soil as it is guided past the point and shank to place the rolled soil back in place with a more uniform density, deter formation of voids or air pockets, and otherwise replace the rolled soil in the wake of the point. In crop agricultural, including in minimum tillage cultivation, it can provide a receptive sub-soil seed bed.

Another aspect of the invention is to use a plurality of the above-described apparatus on an implement that can be controlled as to depth of penetration of the sub-soil during operation. Lateral spacing of the points can be selectively adjusted, as can working depth. In one embodiment the implement is a multi-row minimum tillage implement that can include or be followed by planter row units aligned with the soil-rolling sub-soilers.

Another aspect of the invention is a method of sub-soil ground working. The soil is slit by a blade-like shank with a sub-soiler point. Soil is rolled around the sides of the point and shank. The rolled soil is placed into the relatively same layer of sub-soil as it was prior to soil slitting. The rolling and replacement promote more uniform soil density and deters voids or air pockets. This can be applied to minimum tillage and strip tillage crop applications.

These and other objects, features, aspects, and advantages of the invention will become more apparent with reference to the accompanying specification.

### BRIEF DESCRIPTION OF THE DRAWINGS

### A. Background Prior Art

FIGS. 1A, 1B, 1C-D, and 1E are illustrations of prior art sub-soiler grounding tools.

FIG. 1A shows a prior art subsoiler for the basic structural elements of such devices. Some type of implement frame 1 has a downward depending shank blade 2 that can be adjusted such that the lower body or point 3, and part of shank 2 can penetrate and move in direction D below the surface of soil S, namely, in the subsoil. In this example, subsoiler point body 3 has a leading edge, tip or point 4 with an upper side 5 and an underside 6. Left and right sides 7R and 7L (only 7L shown) are along body 3. Sometimes a trailing tail or member 9 follows the subsoiler body 3 in direction D through the subsoil.

FIG. 1B shows another example from the prior art. Subsoiler body 3, in this case, has a leading point and then a relatively larger cross-sectional main body that functions like a mole, bullet, or torpedo when dragged through the subsoil by movement of implement 1 by a mode of force such as a tractor.

FIG. 1C shows another version of a subsoiler 3. It has a relatively sharp tip or point 4, somewhat of a vertical cutting blade on top at 5, and then some lateral structures at sides 7R and L. As shown in FIG. 1C, a plurality of such subsoilers 3 can be mounted at the lower end of a plurality of shanks 2 at spaced apart lateral positions along an implement 1 to cover a substantial width of ground of an agricultural field.

FIG. 1D is an example, in side elevation, a single subsoiler 3 of FIG. 1C in soil S. As can be seen, the vertical shank 2 is relatively thin and has a leading upper surface 5 that is like a blade. It cuts through at least top subsoil layer S1 as well as S2 and S3. The subsoiler point 4, bottom 6, and sides 7R and L affect subsoil layers at and around S4. Subsoil S5 beneath the travel of body 3 can be partially affected. See output layers S6. By raising or lowering mechanisms on implement 1, the depth of the subsoiler body can be adjusted.

FIG. 1E shows a still further example of a sub-soiler tool. A cutting blade or shaft 2 has a subsoiler body 3 that is basically a lateral but inclined plate that would disrupt and lift soil. Either of points 4A or 4B could be mounted underneath plate 5 to help cut through the ground. In this example, a mole 9 is chained to the back 8 of body 3. Plate 5 and tip 4A or 4B disrupts soil. The mole body 9, cylindrical, bullet or torpedo in shape, helps form side walls around a round and cross-section channel in the subsoil.

A wide variety of subsoiler bodies, points, and trailing devices have been attempted for different functions. Sometimes the leading point and main body of the subsoiler disrupt and move soil from layer S4. For example, the plate 5 of FIG. 1E would act as a ramp and move soil from layer S4 up and away. There are reasons it is beneficial to break hardpan type soil up and yet not move it substantially away from its native depth.

### B. Generalized Exemplary Embodiment of the Invention

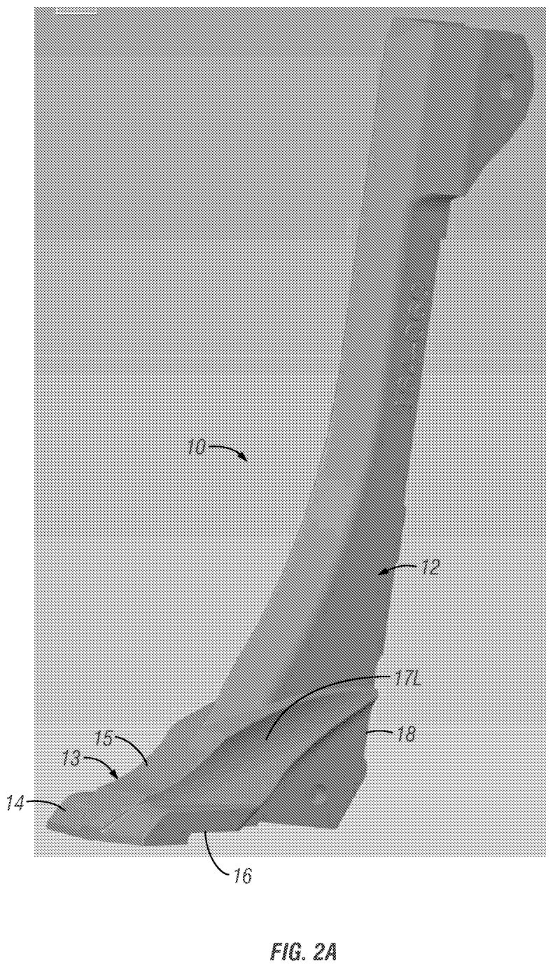

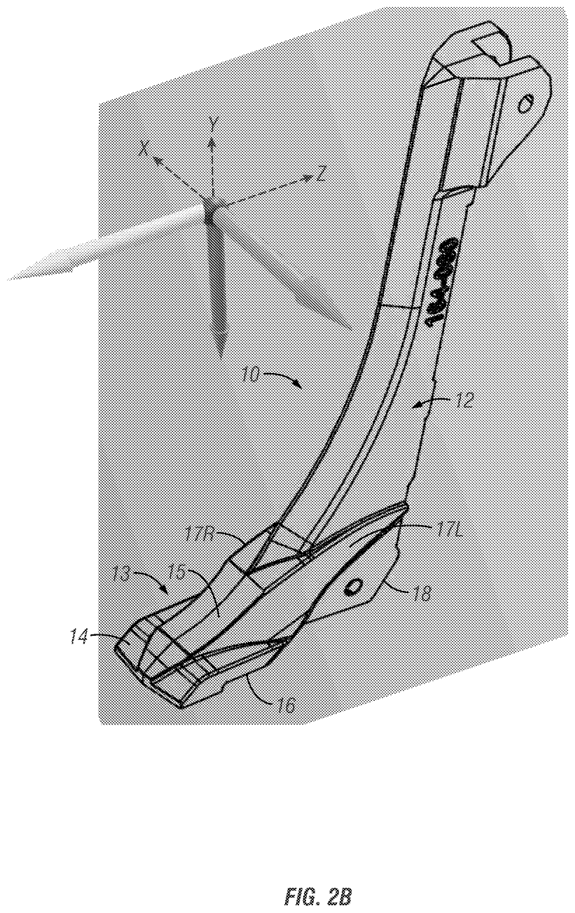

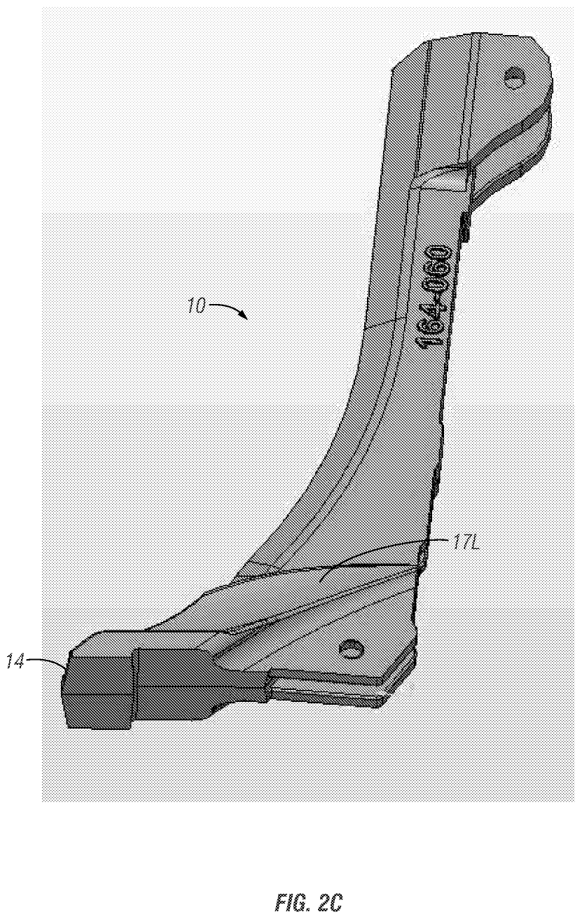

FIGS. 2A-C is a reduced-scale perspective view of an exemplary embodiment according to aspects of the present invention. FIG. 2A is a solid model illustration; FIG. 2B is a line drawing, including a coordinate system that will be referred to from time to time in the description.

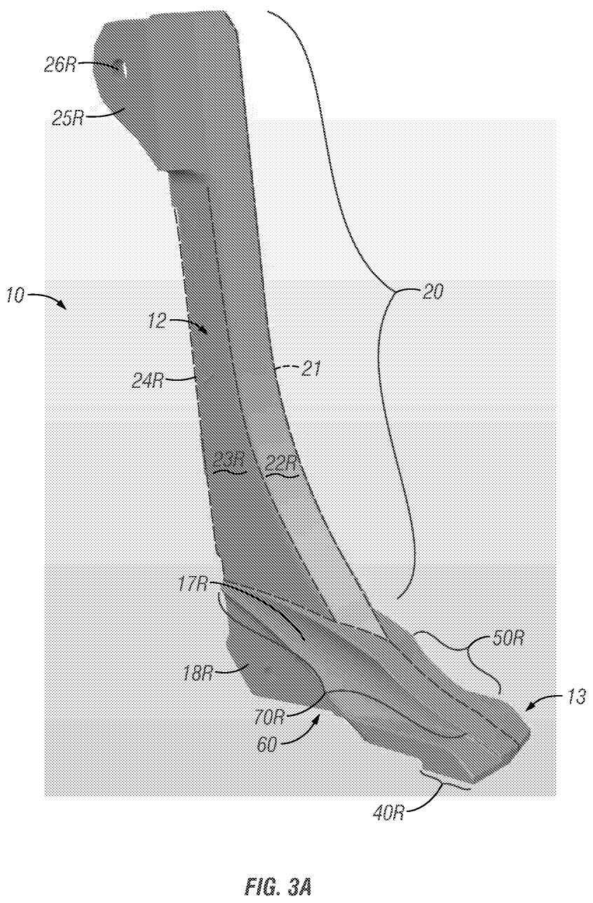

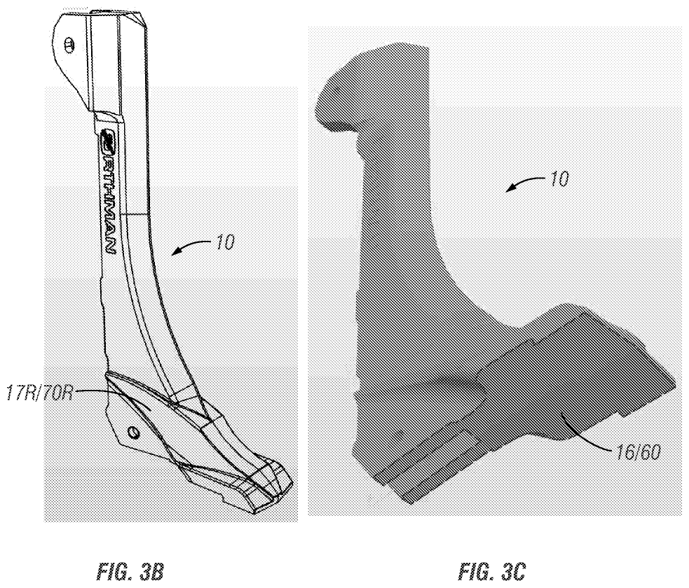

FIGS. 3A and B are similar to FIGS. 2A-B but from a different perspective.

FIG. 3C is similar to FIG. 2C but from a different perspective.

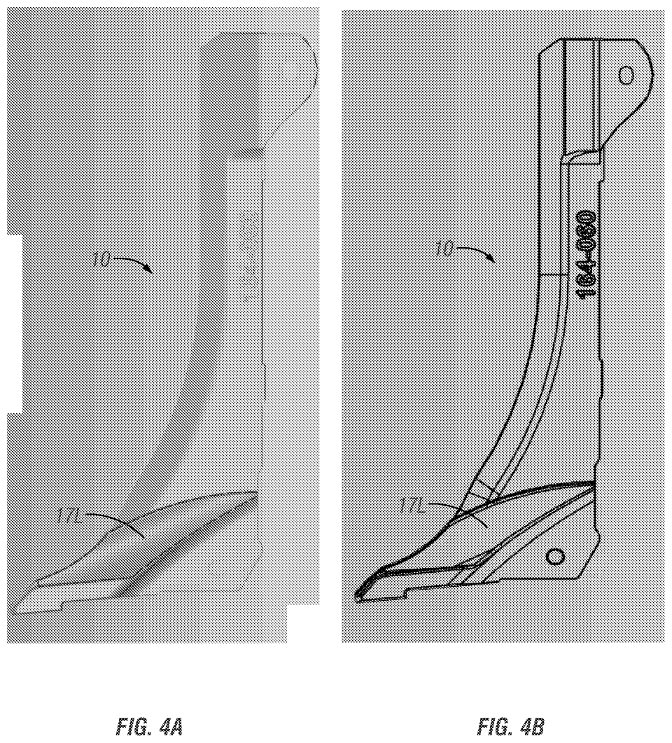

FIGS. 4A-B, 5A-B, 6A-B, 7A-B, 8A-B, and 9A-B are solid model and line drawing versions, respectively, of left side elevation, right side elevation, top plan, bottom plan, front elevation, rear elevation of the embodiment of FIGS. 2A-B.

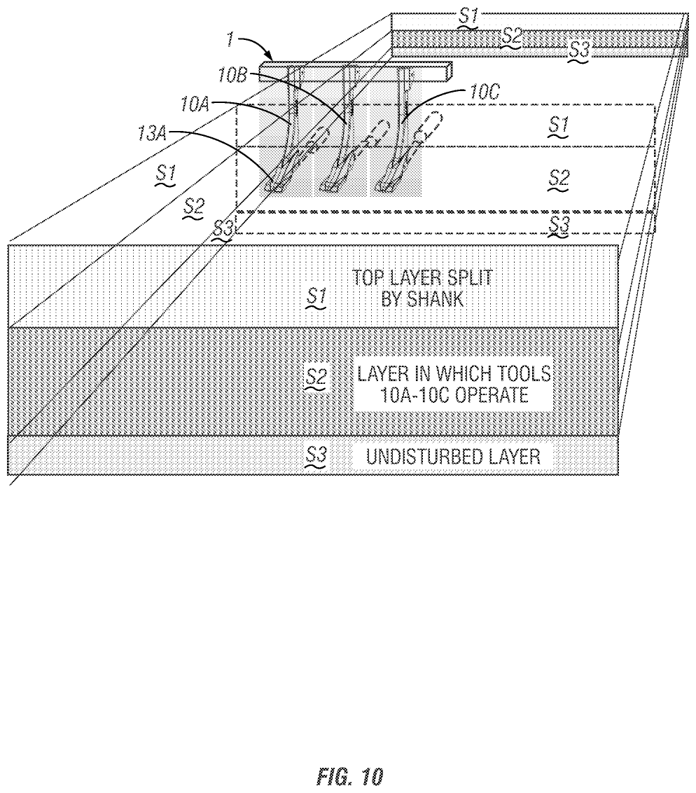

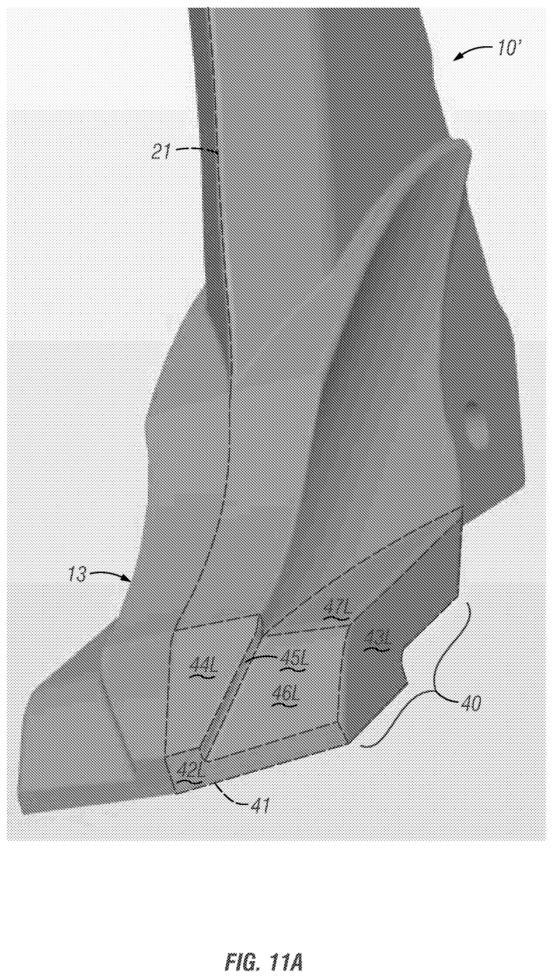

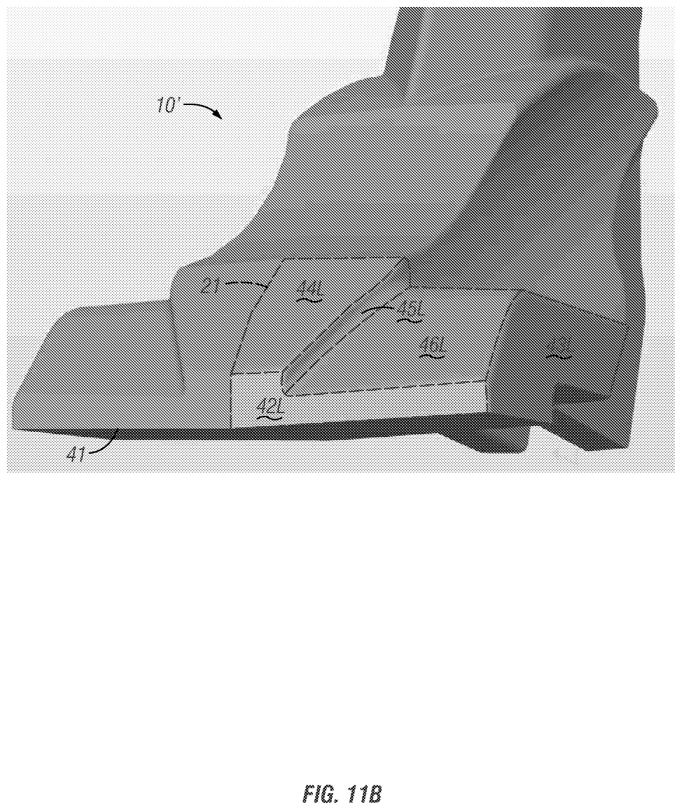

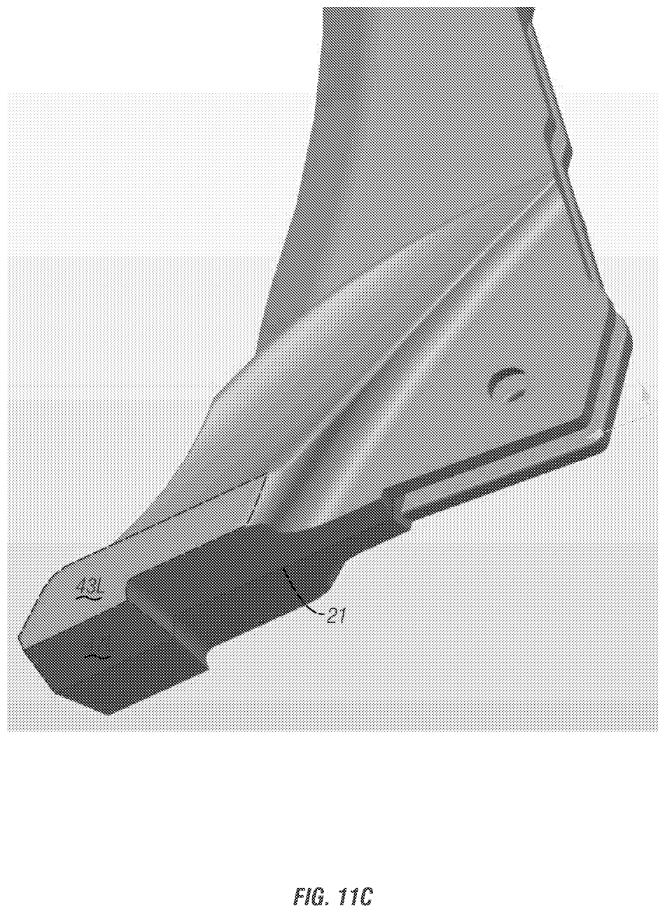

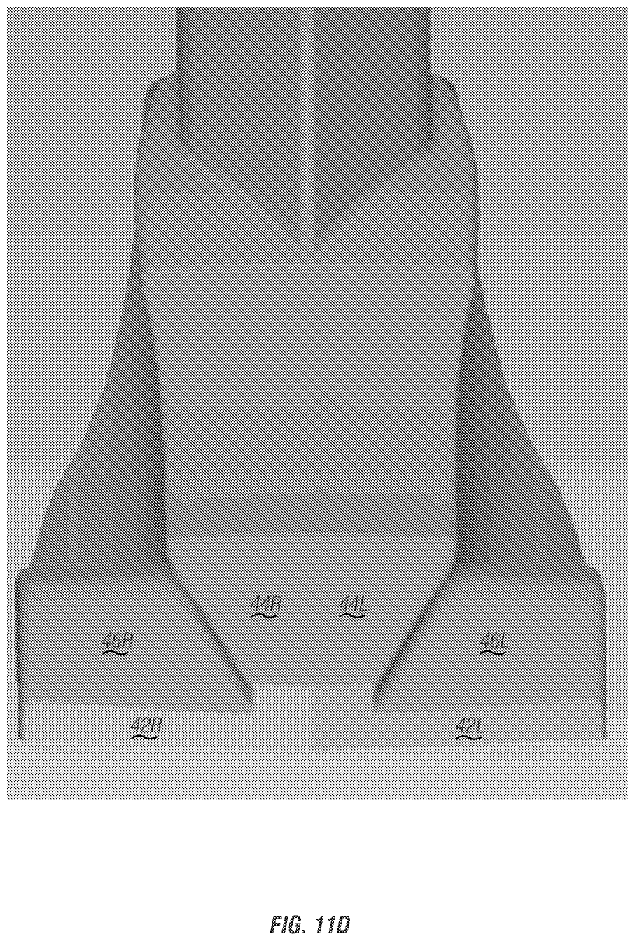

FIG. 10 is a diagrammatic view of a plurality of the tool of FIGS. 2A-B relative to sub-soil layers.

### C. First Specific Exemplary Embodiment of the Invention

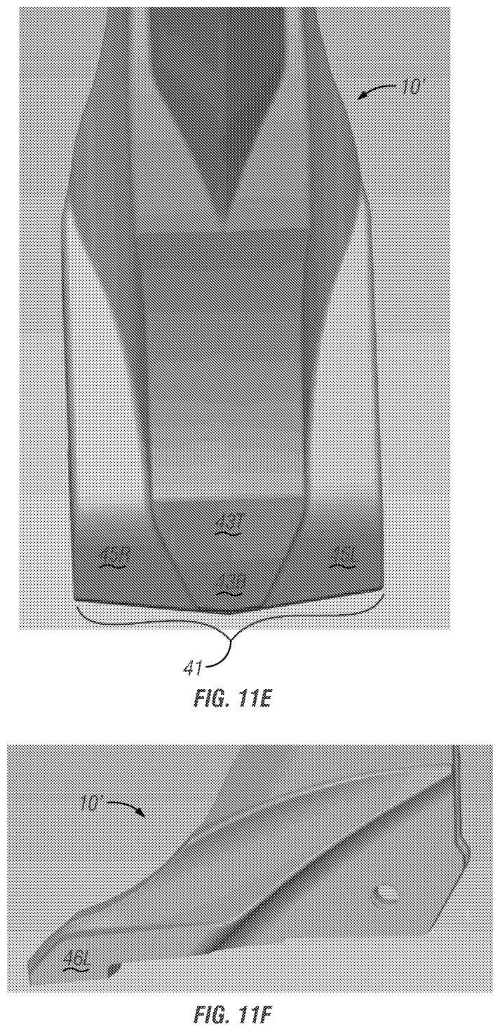

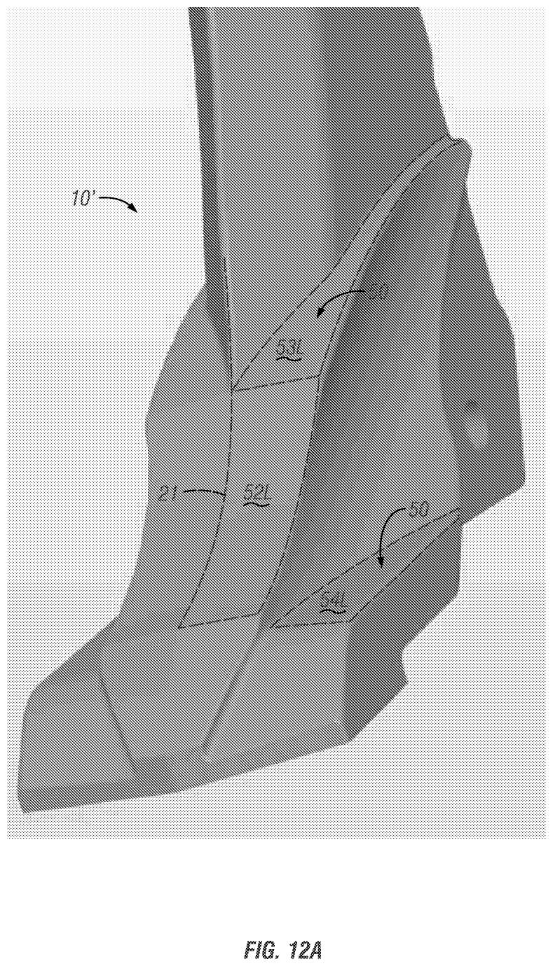

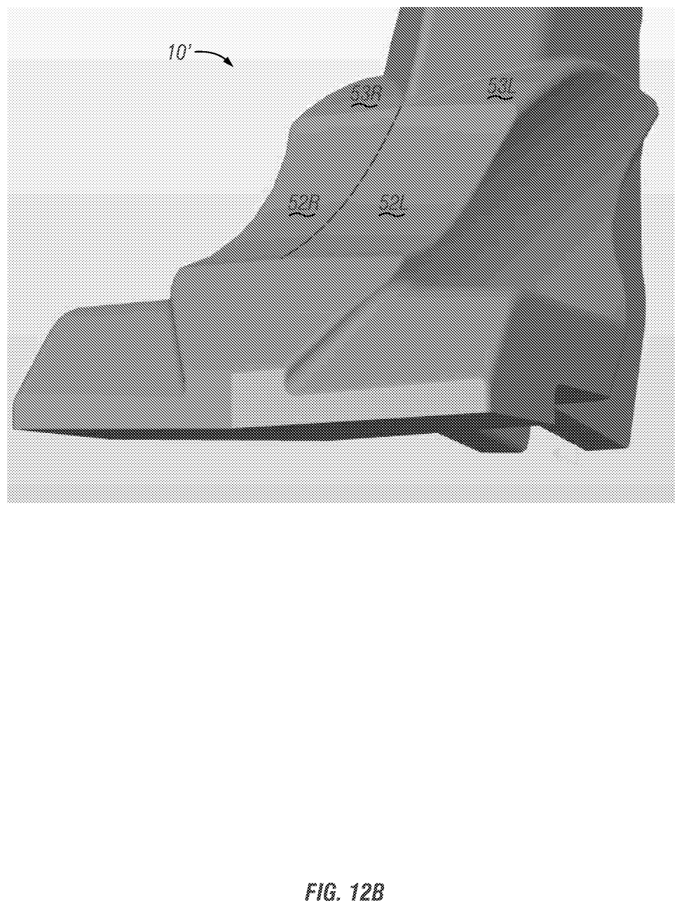

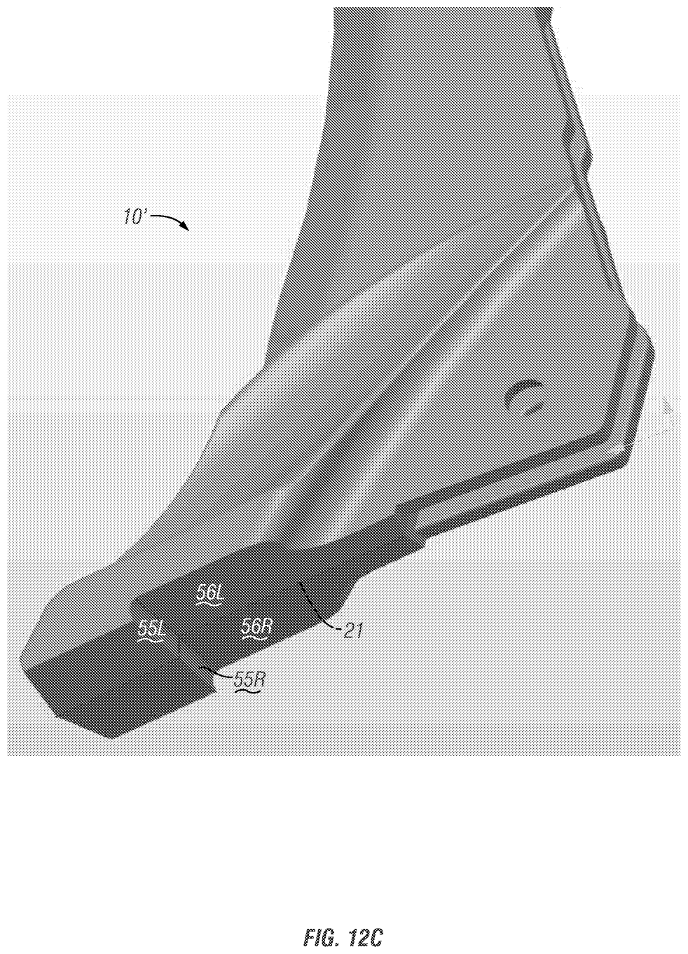

FIGS. 11A-F are various isolated and enlarged views of the sub-soiler point of the embodiment of FIGS. 2A-B, annotated to highlight specific features of a leading end section of the point body.

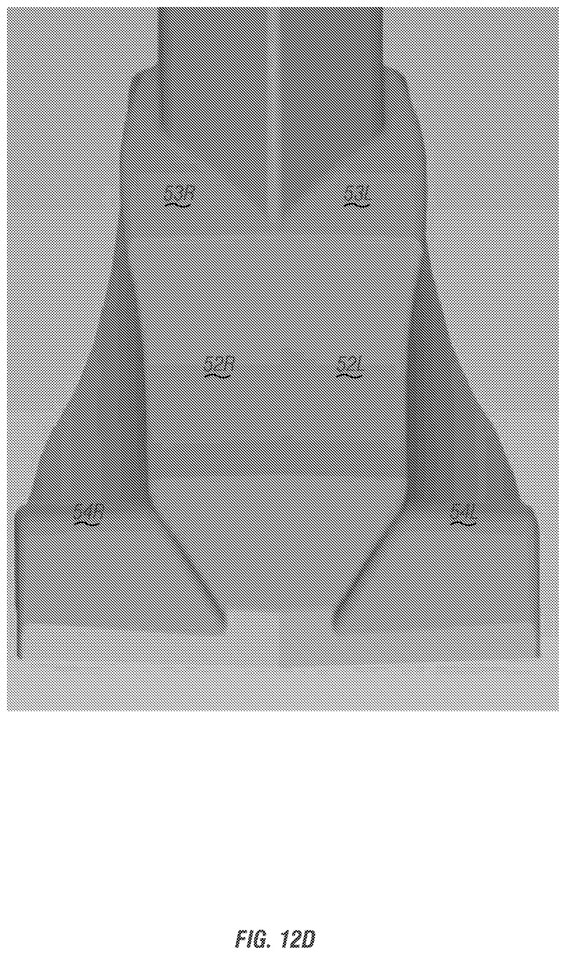

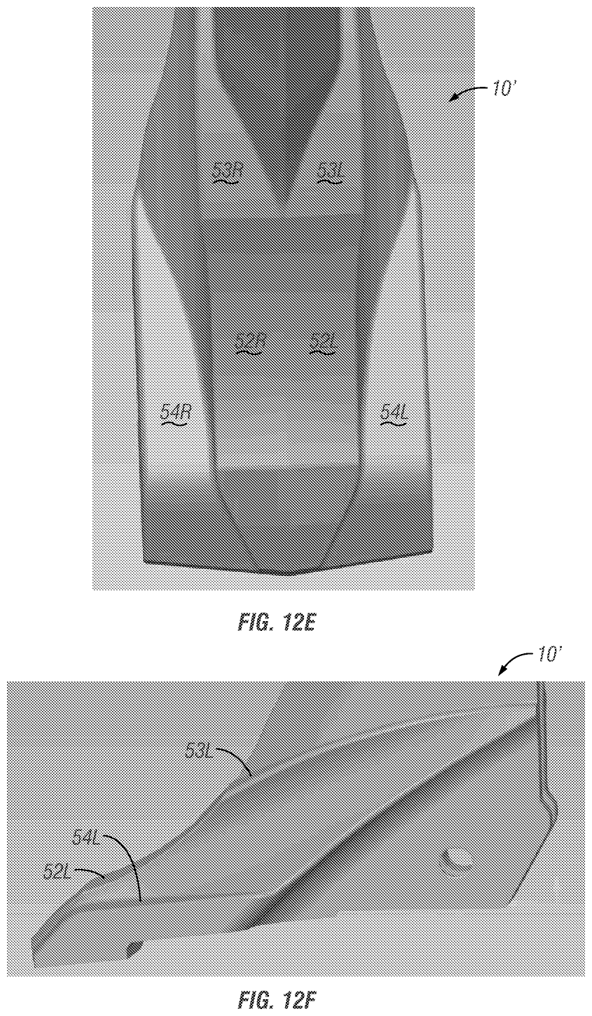

FIGS. 12A-F are various isolated and enlarged views of the sub-soiler point of the embodiment of FIGS. 2A-B, annotated to highlight specific features of an upper portion of the point body.

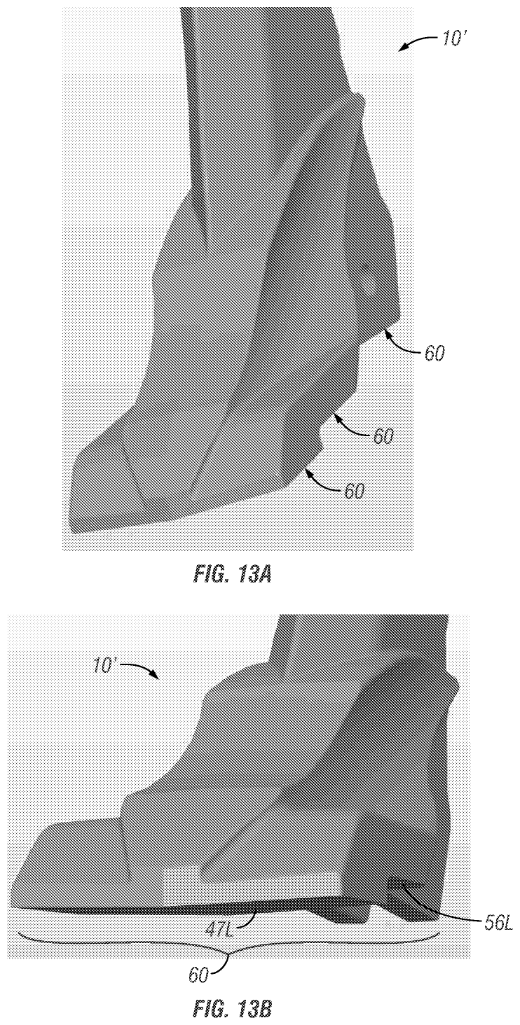

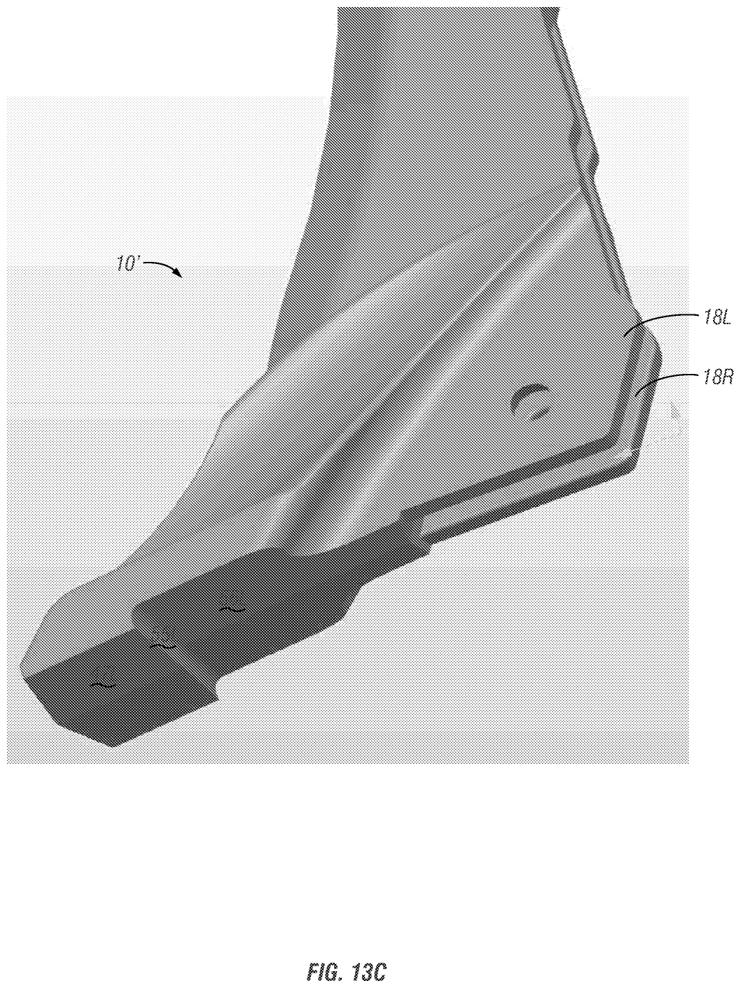

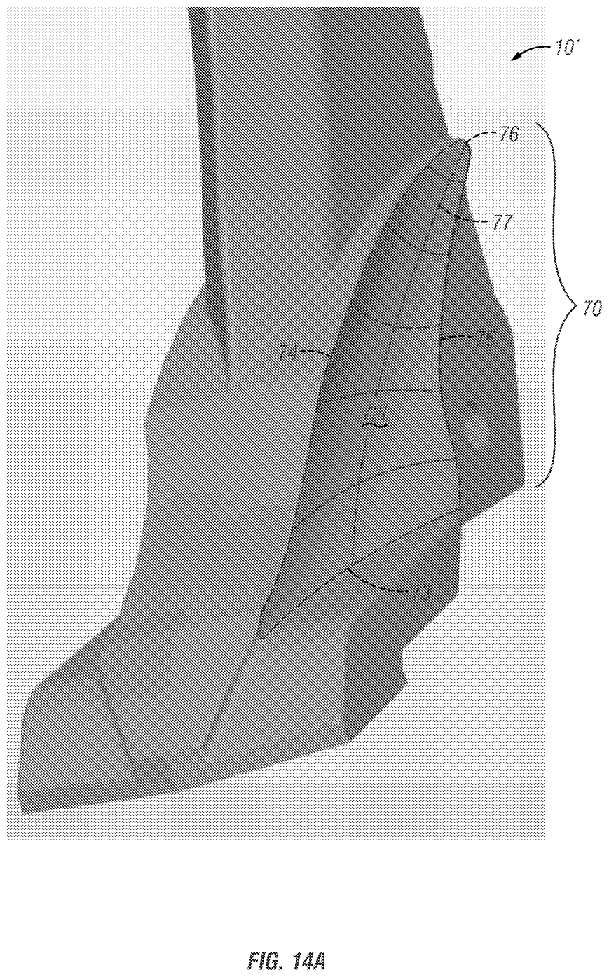

FIGS. 13A-C are various isolated and enlarged views of the sub-soiler point of the embodiment of FIGS. 2A-B, annotated to highlight specific features of an underside or bottom portion of the point body.

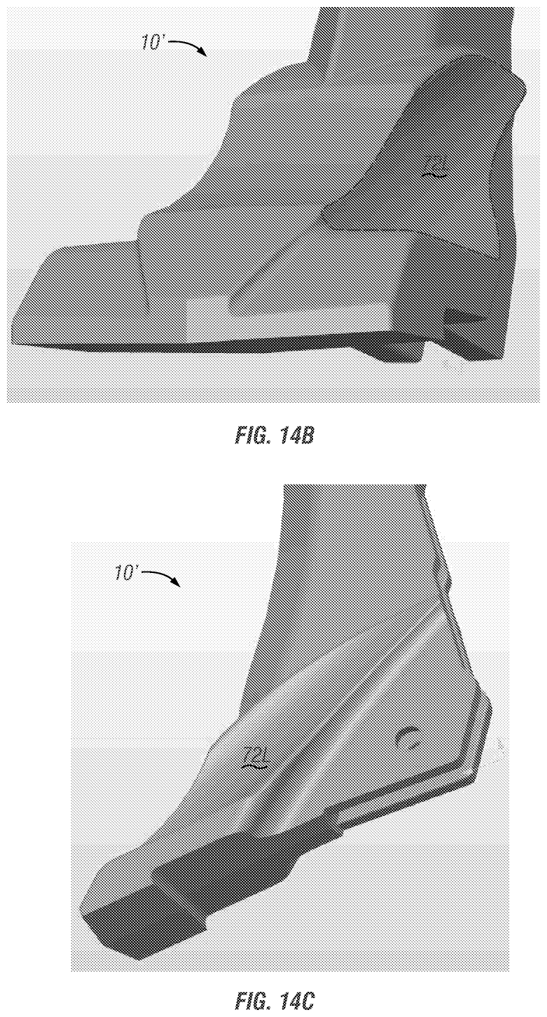

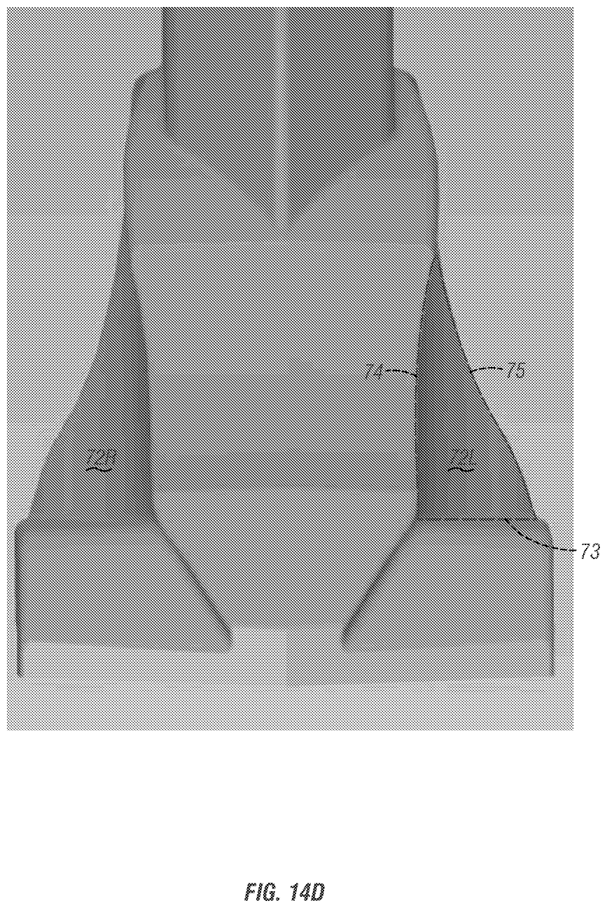

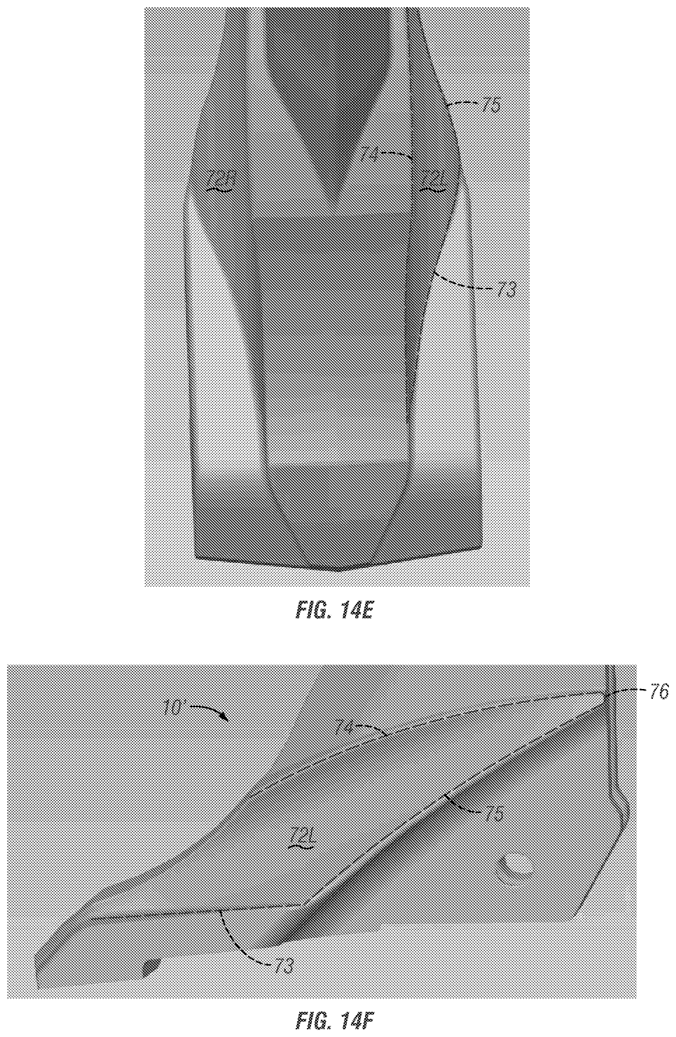

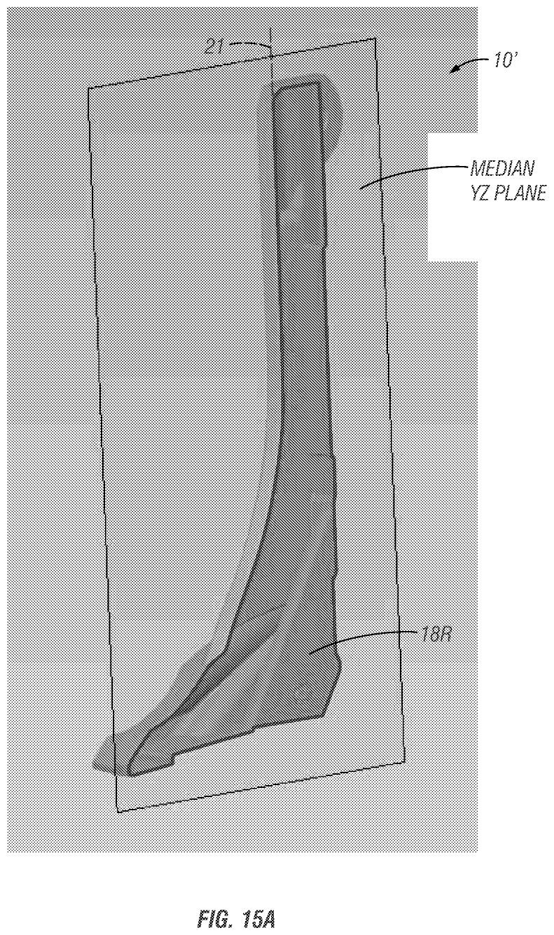

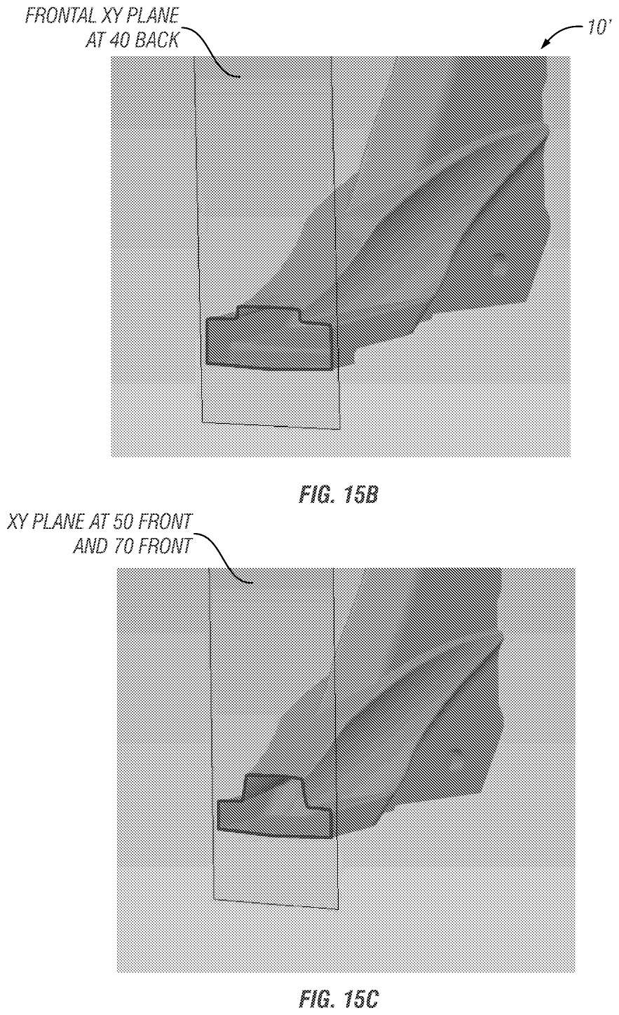

FIGS. 14A-F are various isolated and enlarged views of the sub-soiler point of the embodiment of FIGS. 2A-B, annotated to highlight specific features of a side soil-rolling feature of the point body.

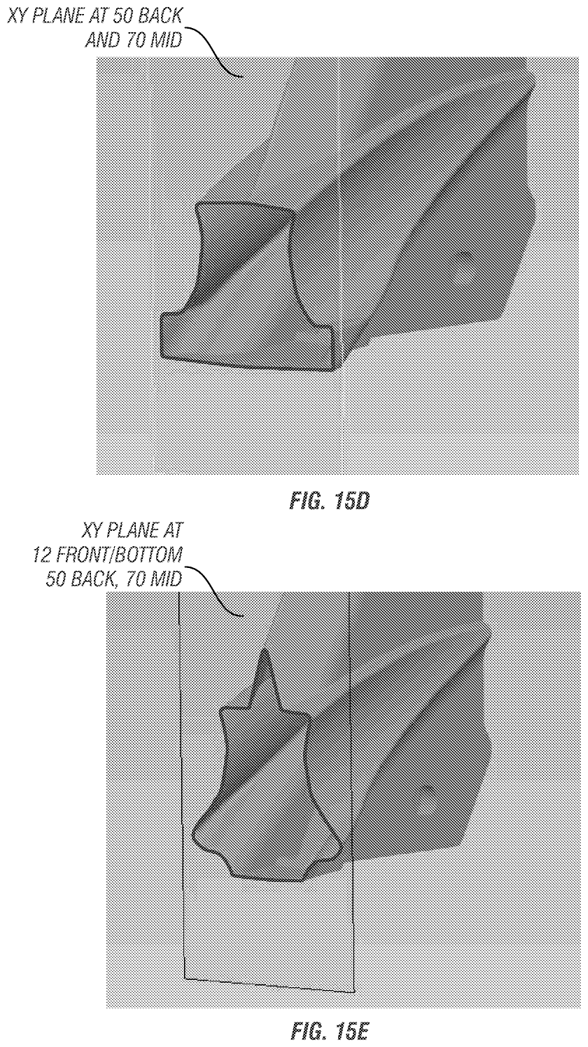

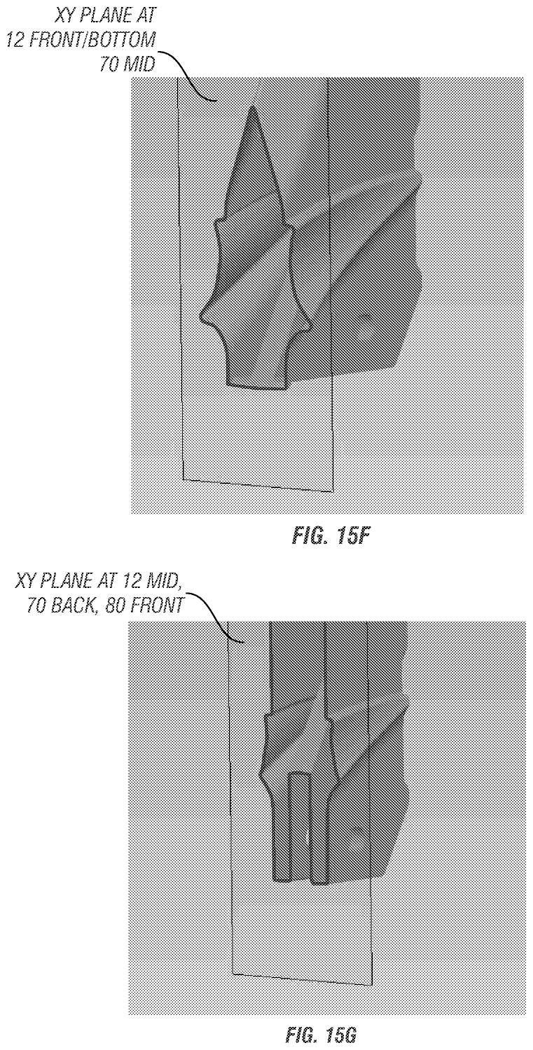

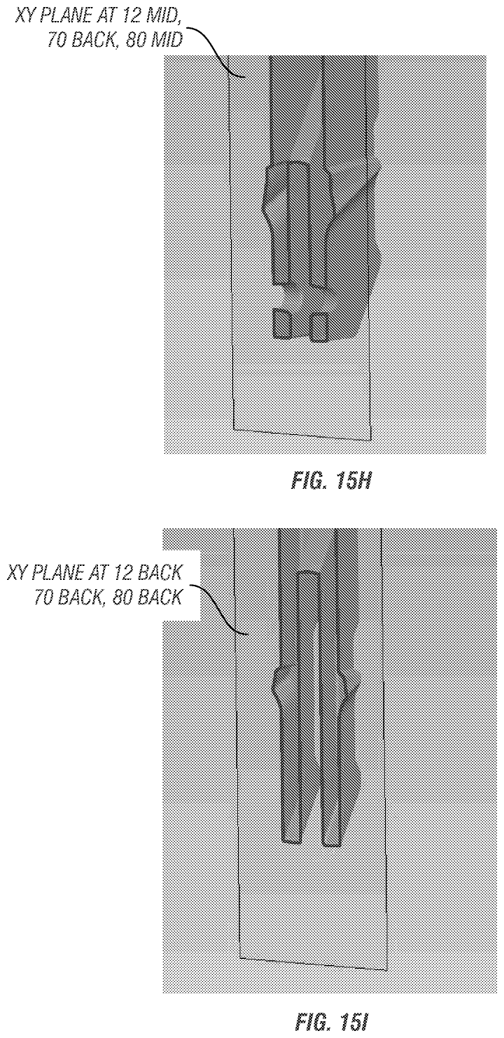

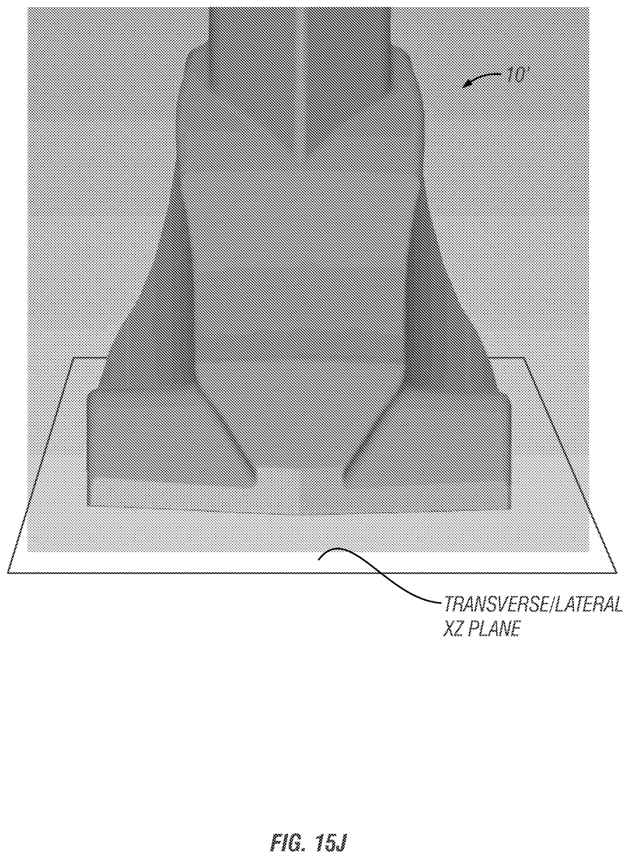

FIGS. 15A-J are sectioned diagrammatic views showing profiles of the sub-soiler tool and tip of FIGS. 2A-B.

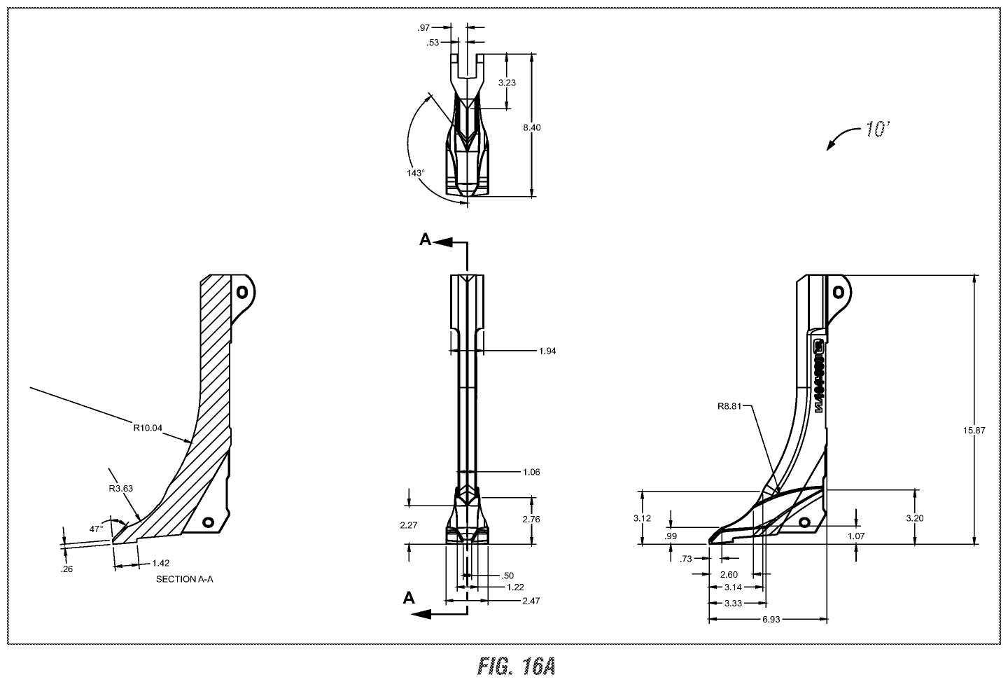

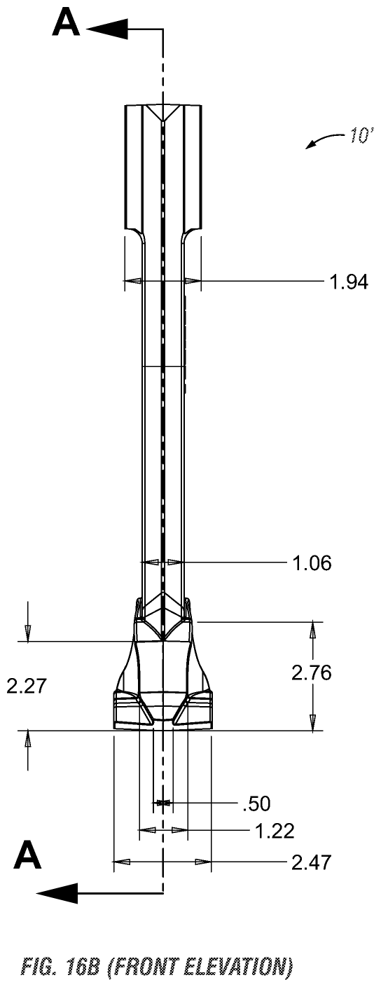

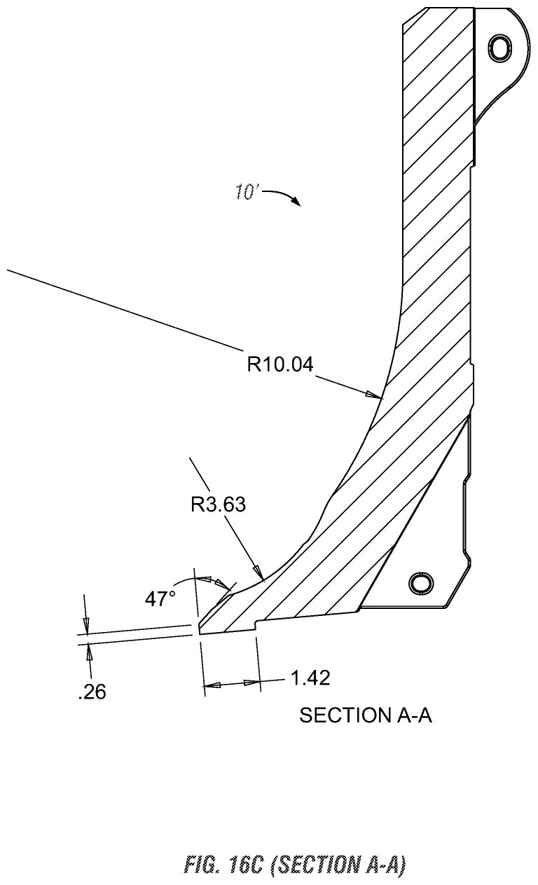

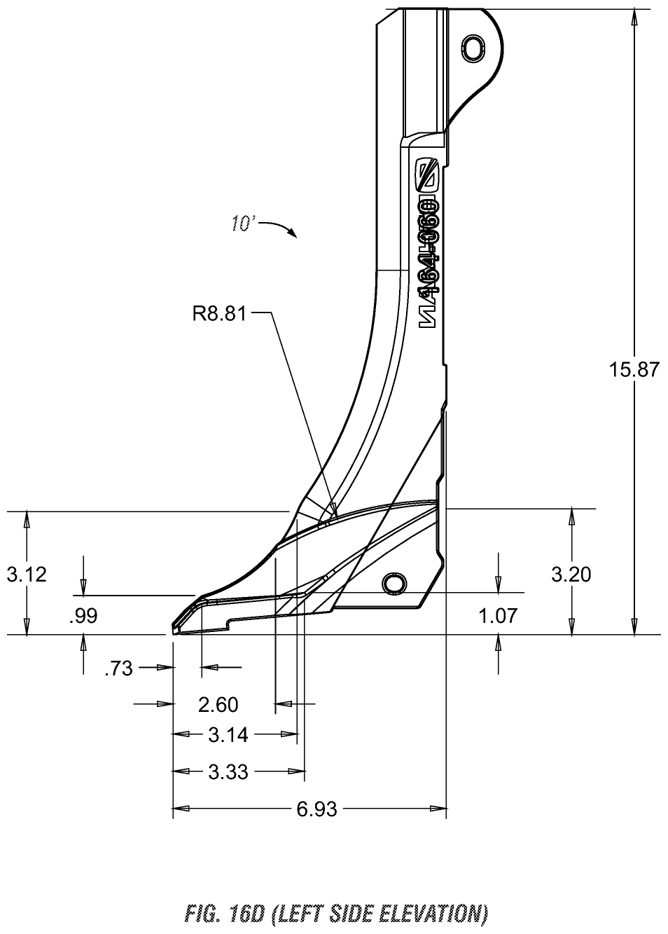

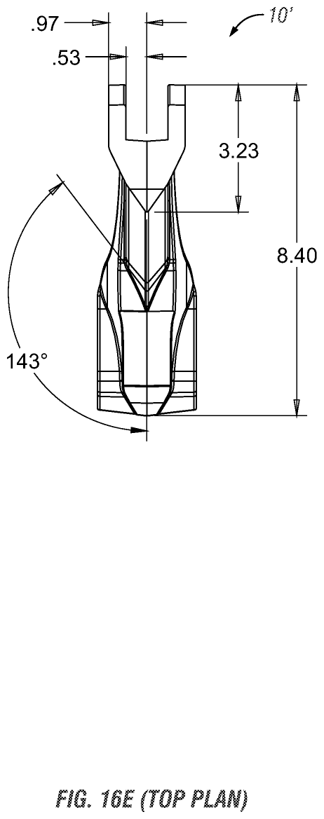

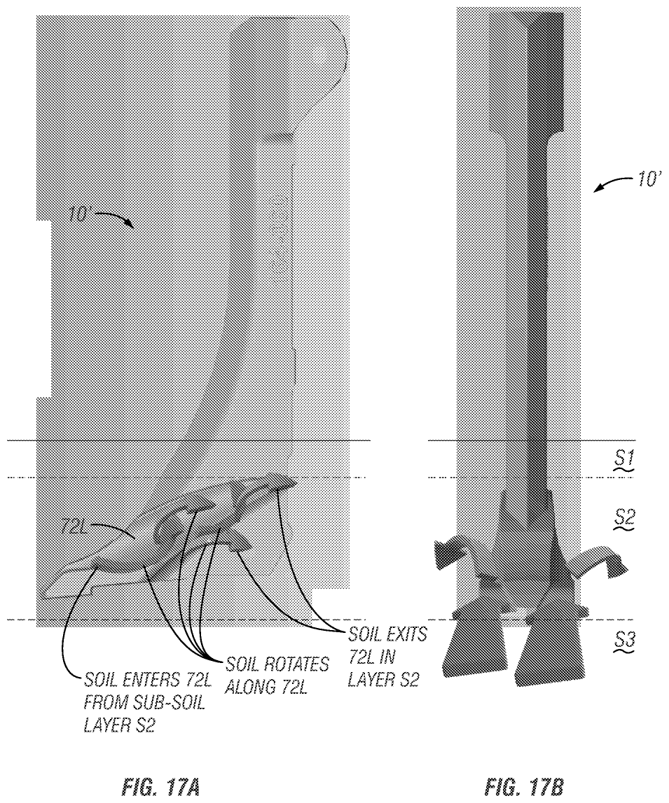

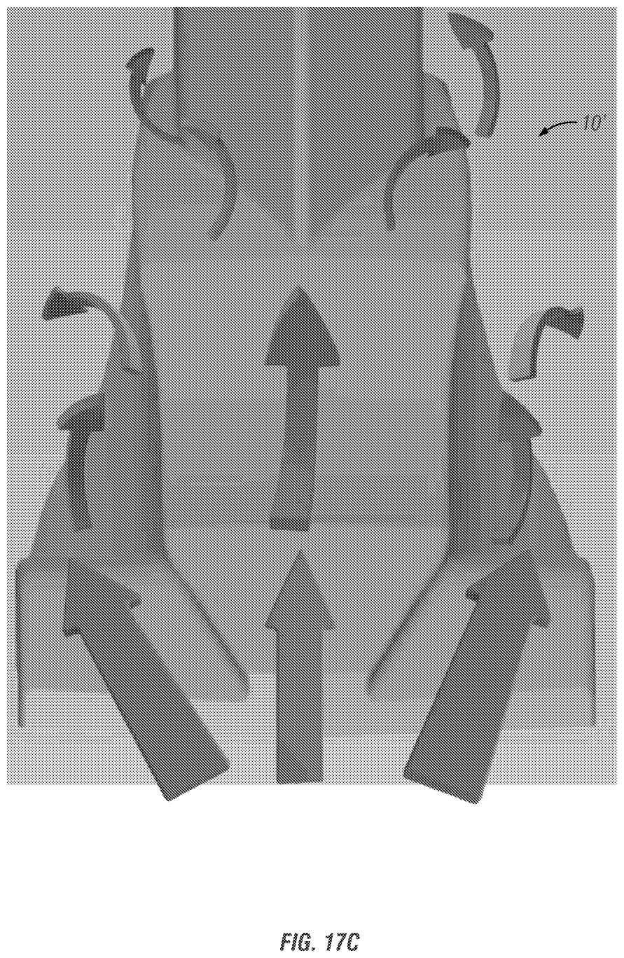

FIGS. 16A-E are perspective and isometric views of a specifically dimensioned first specific exemplary embodiment according to aspects of the invention.

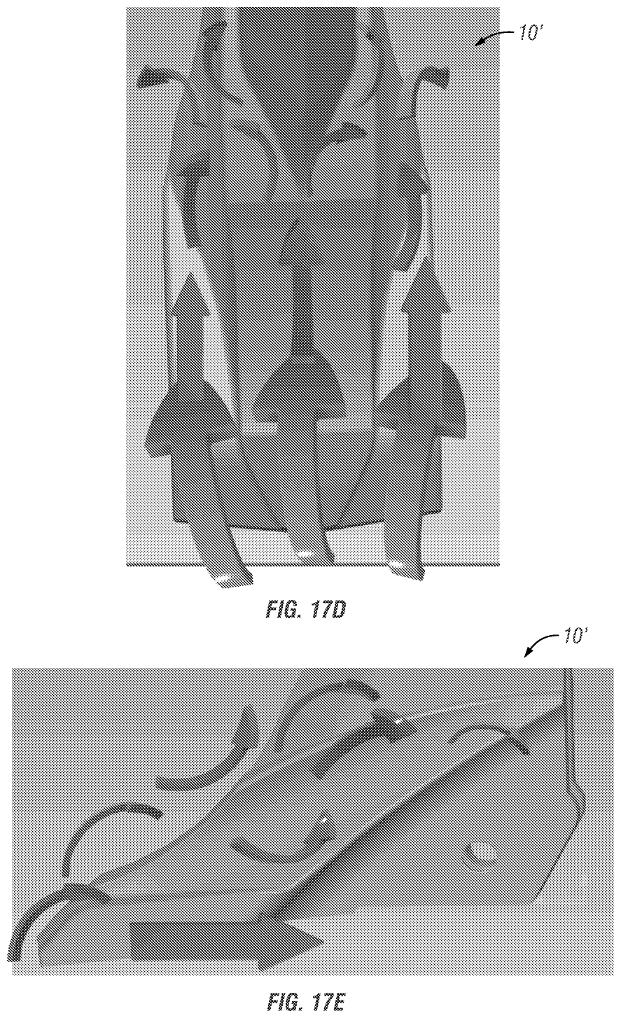

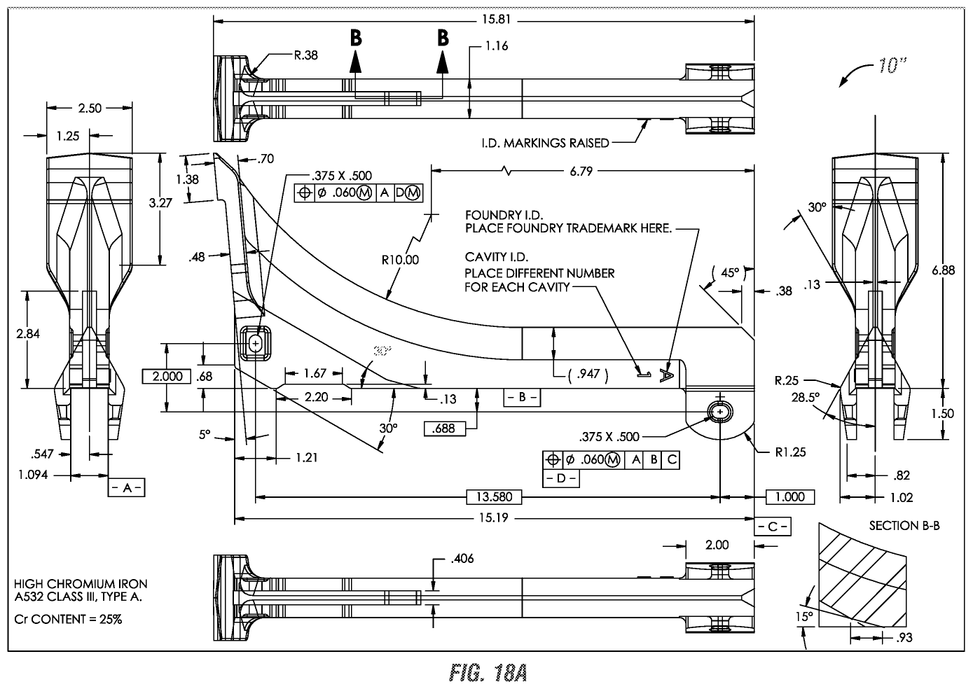

FIGS. 17A-E are diagrammatic illustrations of how the embodiment of FIGS. 16A-E rolls soil during operation.

### D. Second Specific Exemplary Embodiment of the Invention

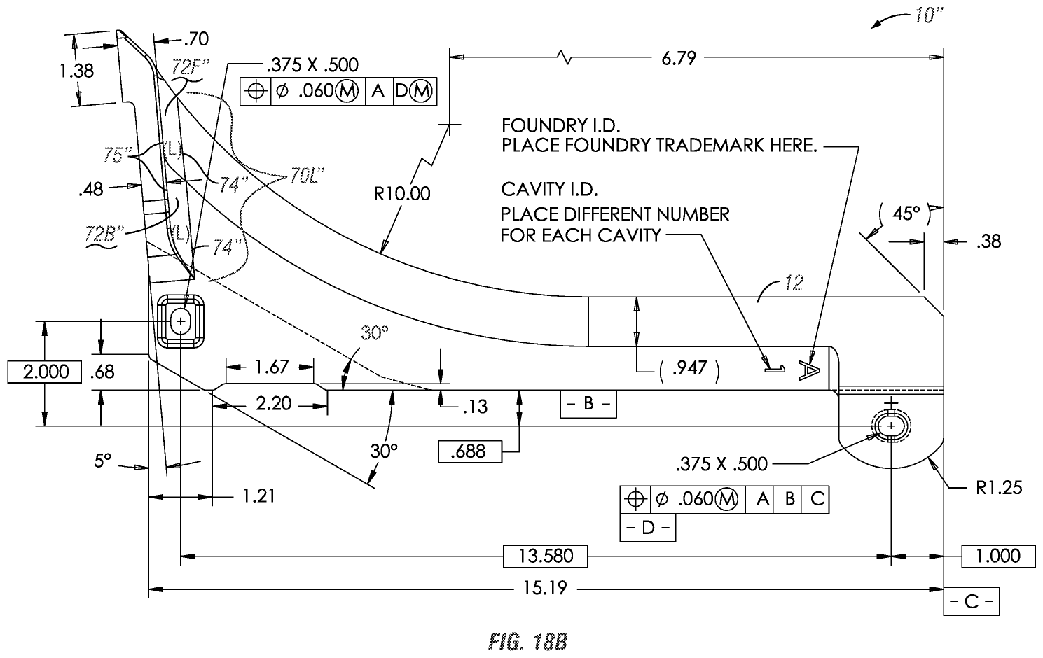

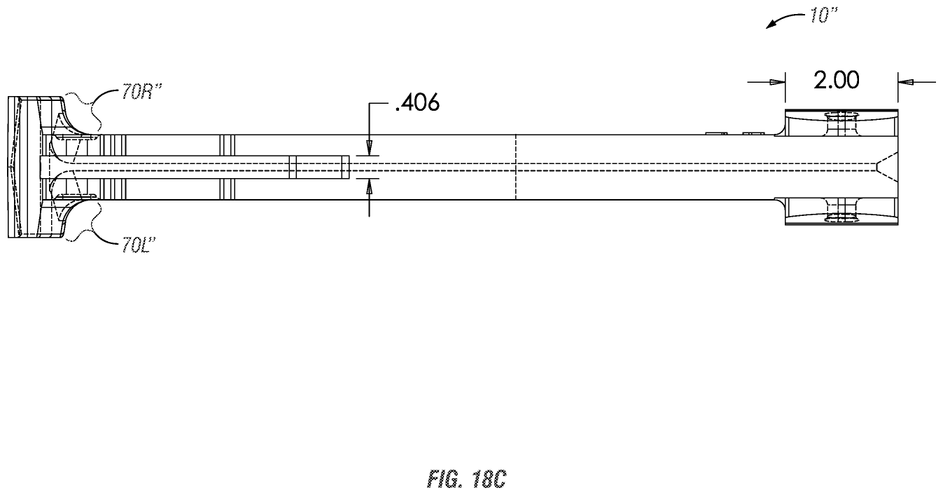

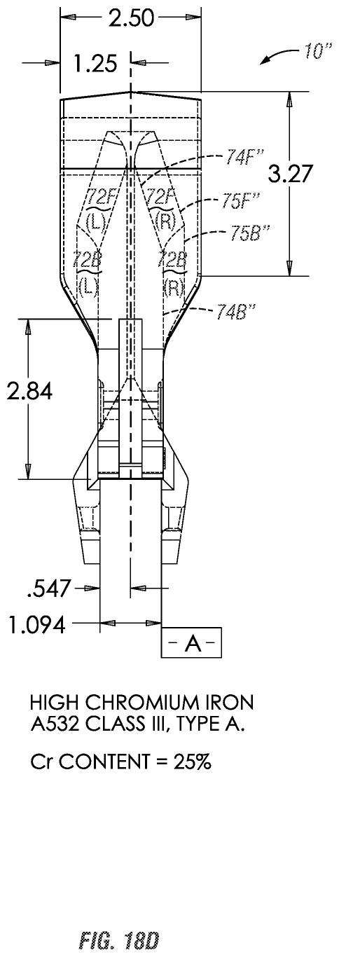

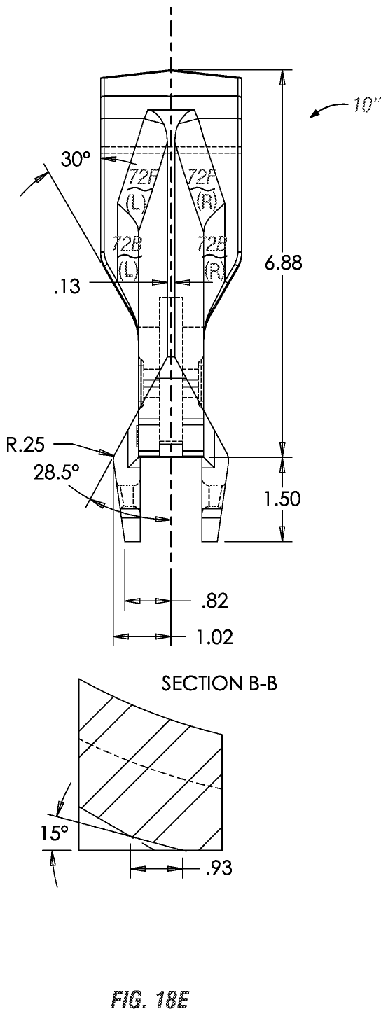

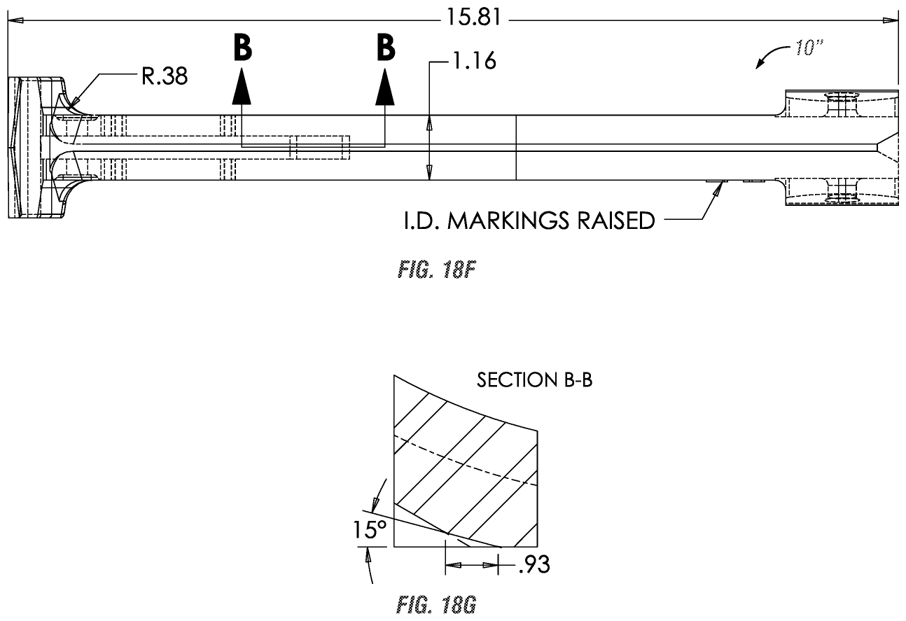

FIGS. 18A-G are perspective and isometric views of a specifically dimensioned alternative specific second exemplary embodiment according to aspects of the invention.

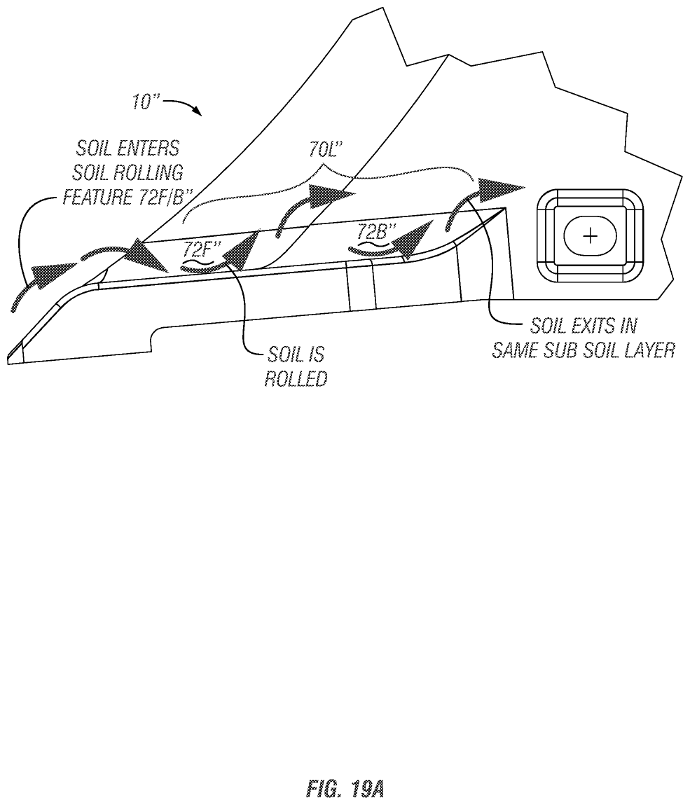

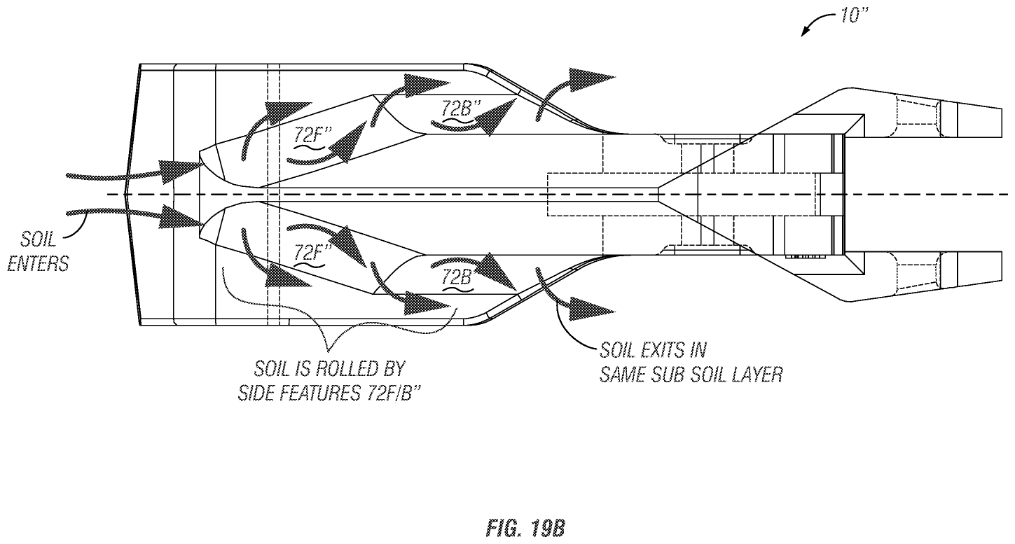

FIGS. 19A-B are diagrammatic views of soil rolling with the embodiment of FIGS. 18A-G.

### DETAILED DESCRIPTION OF EXEMPLARY EMBODIMENTS OF THE INVENTION

### A. Overview

For a better understanding of the invention, several ways the invention can be implemented will now be described in detail. It is to be understood that these examples are neither inclusive nor exclusive of all embodiments the invention can take. For example, variations obvious to those skilled in this technical art will be included within the invention even if not specifically or explicitly described.

The embodiments focus on a sub-soiler tool useful for minimum tillage agriculture. However, aspects of the invention can apply as well to other agricultural or sub-soil modification tasks.

The embodiments focus on a scale for the sub-soiler tool that is indicated in the dimensioned drawings. Also, the drawings indicate general proportions of features relative to each other. However, the tool is not limited to those dimensions and can scaled up or down depending on need or desire, the proportions can vary according to need or desire.

### B. Generalized Exemplary Embodiment

With reference to FIGS. 2A-B through 10, a generalized exemplary embodiment according to aspects of the invention will be described.

Overall apparatus or tool 10 includes a shank 12 which serves to attach to a frame of an implement and create a vertical slice in the soil when dragged through the soil.

At the lower end of shank 12 is a sub-soiler point (generally at 13). Point 13 includes a forward leading cutting edge portion 14, an upper portion 15, an underside or bottom portion 16, side surfaces 17L and 17R (symmetrical and on both opposite sides), and back or trailing portion 18.

As is appreciated by those skilled in the art, in operation shank 12 is substantially vertical and generally in the YZ plane of FIG. 2B. Leading edge 14 begins forward of the lower end of shank 12 and is generally in the XZ plane or horizontal in operation. In this embodiment, leading edge portion 14, upper portion 15, part of bottom portion 16, and at least part of side features 17L and R extend symmetrically and laterally wider than the width of shank 12 in the XY plane of FIG. 2B. The YZ plane will sometimes be referred to as the medial plane (as it sections tool 10 along its longitudinal axis from front to back; in this embodiment it separates tool 10 into opposite symmetrical lateral sides). The XZ plane will sometimes be referred to as the transverse or lateral plane (as it sections tool 10 horizontally front to back). The XV plane will sometimes be referred to as the frontal plane (as it sections tool 10 vertically side-to-side laterally).

One feature of tool 10 compared to the prior examples of FIGS. 1A-E is side surfaces 17L and R. They are generally concavely radiused in cross-section relative the frontal XY plane all the way front to back. Leading cutting edge 14 penetrates soil, lifts some of it slighting, and feeds it to surfaces 17L and R as the tool 10 moves forwardly in the ground. The radiused surfaces 17R and L are designed to roll the soil as it moves front to back, but also deposit the rolled soil substantially at the same depth it started. The wake of tool 10 would therefore be filled back in with soil from its starting sub-soil depth, but the rolling promotes uniform density and deters air pockets. Instead of just slitting soil with just a vertical shank, or slitting soil with a vertical shank and a vertical plate-like point like FIG. 1A or with plate-like lateral horizontal wings like FIGS. 1C-D, tool 10 intentionally rolls the soil with radiused symmetrical side surfaces 17L and R. Instead of slitting soil with a vertical shank and then creating a sub-soil tunnel or channel with a wide body or mole such as in FIGS. 1B and 1E, tool 10 rolls soil around opposite sides of its shank but fills in the wake of its point with the rolled soil.

The radiused side surfaces 17L and R do not extend substantially laterally from shank 12 and are fed soil from leading edge 14. They can essentially be “built-in” profiles. They do not need to be separated manufactured or mounted, which adds complexity and cost. They do not substantially increase drag of tool 10. Yet shank 12 cuts/slits even hard pan ground, plant residue, and debris, and point 13 penetrates and breaks up even hard sub-soil or large clods or debris. The radiused side surfaces 17L and R then roll the soil. This can be beneficial for different applications. One is strip tillage, including minimum tillage. An induced subsurface thin pancake stacking effect can occur with high intensity rain events or excessive watering due to over-irrigation caused by silt and clay sized particles oriented in a laminar fashion. This tool point disrupts those root, clogged soil pores, air/atmosphere flow limitations, and water impeding layers with first an undercutting-lift and roll fashion under the laminar formed soils. With said tool point, soils are ameliorated to have significantly reduced the laminar features that inhibit downward water movement, clogged and/or discontinuous vertical soil pores can regenerate to a more natural soil condition.

Thus, this feature alone can provide at least one or more of the objects of the invention. While the FIGS. 2A-B show a particular form factor for soil rolling side surfaces 17L and R, they can take different form factors so long as they are effective to roll soil and replace the rolled soil in the wake of the point. Further discussion of the function and benefits of such soil-rolling side features follows.

FIGS. 3A-C show shank 12 of this exemplary embodiment includes an elongated body 20 with a leading/cutting edge 21 along a median YZ plane. Each lateral left (L) and right (R) side of tool 10 is symmetrical (right side shown in FIG. 3A). For example, surfaces 22R and L diverge symmetrically angularly and rearwardly from edge 21 to sides 23R and L terminating in a back 24R. Symmetrical tabs 25R and L and apertures 26R and L are one way shank 12 can be mounted to an implement frame. Point 13 includes symmetrical portions 40R and L at the leading cutting end, symmetrical upper surfaces between portions 40R and L, and symmetrical shank portions 22R and L.

Symmetrical side soil rolling features/surfaces 17L and R extend from near the point front to its back and present a concave, radiused height relative the medial or YZ plane. As can be seen, in this exemplary embodiment, soil rolling surfaces 17L and R have compound form factor. One is a concave curvature in cross-section front to back. Soil that is fed to side surfaces 17L and R tends to hit the concave front to back shape and roll or rotate, but also stay substantially at or near the same depth level in the sub-soil. This promotes loosening, breaking up into smaller pieces, and a more uniform density after passage of tool 10, but replacement of the worked/conditioned rolled soil at or near the same depth level. This promotes a good seed bed for planting seeds and growing them to plants, if used for that purpose. Features 17L and R are basically built into the sides of tool 10 at or near the level of the sub-soil tip. The depth of the sub-soil tip 13 can be adjusted by techniques known in the art. This usually involves changing the relationship between the implement frame and the surface of the ground.

Thus, the generalized embodiment has side soil-rolling features 17L and R extending from towards the front of tip 13 to towards the rear, and symmetrical on opposite lateral sides of longitudinal axis 21. In this embodiment, shank 12 includes a leading soil-cutting edge generally along longitudinal axis 21. This helps shank 12 rip a vertical slit along the ground and for a depth in the subsoil. That slit can then help open a seed trench if tool 10 is used with/for planting.

This point eliminates air pockets and inconsistent compaction currently introduced through the strip till practice. With this point a strip if produced with uniform soil density to a selected depth (e.g. 1 to 11 inches) eliminating potential air pockets that are left when existing points are used. This uniform density provides a seedbed that is ideal for planters to run on and limiting the amount of down force the planter needs to exert to ensure the seed is placed firmly at depth. Air pockets in the seedbed limit seed growth, and can cause “hot spots” of fertilizer that can prohibit plant growth. With the new point design these air pockets are eliminated, and the uniform density of the seed bed creates uniformity across the field Eliminating air pockets, induced cold-air tunnels immediately below the seed-placement is of great importance in colder spring soils with this tool point.

The wings or features 17L and R on the sides of the point 13 roll soil rather than shattering or smearing the soil. By rolling the soil, less disturbance is introduced into the soil profile. Smearing occurs when a current point is run through soil with higher moisture creating a dense layer of soil that slows root growth as it has to penetrate this hard, smeared layer. The rolling action also helps soil to settle evenly eliminate air pockets in the strip. The action of this point creates a harmonic wave effect behind it as the point is pulled forward in the soil which minimizes smearing, large air pockets and clods (aggregates larger than 1 inch [2.5 cm] to 3 inch [7.5 cm] in diameter). This has been observed with field testing.

FIGS. 3A-B through 9A-B are various perspective and isolated views of the sub-soiler point 13 and shank 12 of the embodiment of FIGS. 1A-B and 2A-B, to help show side soil-rolling features 17L and R in one form they could take. It is to be understood that they could take a variety of forms. A primary function, regardless of form, is to roll soil as it is fed or passes by those side surfaces 17L and R when moving tool 10 through the soil.

A typical point will push the soil on either side of the point to the side creating a slice that fills back at random. By controlling the soil flow as the point is used the slit created by the point is filled back in as the soil rolls over.

Current points slice through the soil leaving a cavity behind the point that can inhibit plant growth, by rolling the soil around the shank the soil is placed aback in relatively the same location. This leaves a strip that is more uniform in density than currently offered options.

The soil-rolling wing profiles 17L and R on the sides of the point 13 of tool 10 are a beneficial feature that roll the soil rather than slicing it.

Comparable designs include a tillage point with large radii on the point or shank to roll soil around the disturbed area to replace in relatively the same location it was initially located.

The length, thickness, width, and other form factors of tool 10 can vary. FIGS. 1A-B to 9A-B show just one example at reduced scale. For minimum tillage applications, the overall top to bottom height, width, and front to back depth of tool 10 could be on the order of 15 to 16 inches, 0.5 to 1 inch, and 2-4 inches respectively, but this could vary. The height, width, and front to back depth of point 13 could be on the order of 2-3 inches, 3-4 inches, and 6-7 inches respectively, but this could vary. General height, width, and front to back depth of each soil rolling surface 17L or R could be on the order of 1-2 inches, a fraction of an inch, and 6-7 inches, respectively, but this could vary. The radius of curvature of the concave front to back surface 17L or R profile can vary. One example is in the drawings, but this can vary along the length of each surface 17L or R. The surfaces 17L and R do not necessarily have to be symmetrical. They just function to roll soil. As noted earlier, soil rolls because of the shape of the points new shape/form and a harmonic wave flows behind as the tool point is drawn forward through the soil. This wave continues the disruption pattern of the soil at set depths to eliminate dense layers, smeared soil and thin pancake layering effects previously mentioned.

It is to be appreciated that side soil rolling surfaces 17L and R can have other characteristics. One example is that the distance between top and bottom edges of each surface 17 or 50 can decrease front to back. As shown in FIGS. 2A-C to 9A-B, this tapering of surface 17 can be by convergence of the bottom edge towards top edge. In this example, top edge is substantially at or near the transverse, lateral, or XY plane front to back of tool 10, but with a slight front to back incline. But lower edge is at a much steeper front to back incline. This can help roll the soil but also leave it in substantially the same sub-soil depth layer once it passes the trailing edge portion of tool 10. Those top and bottom edges do not have to be linear. In this example they are slightly upwardly convexly curved in XZ plane. These characteristics are not necessarily required.

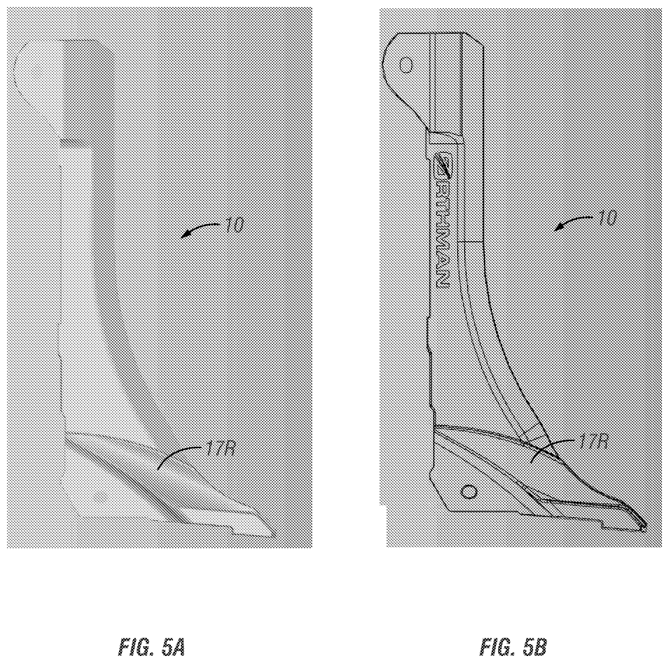

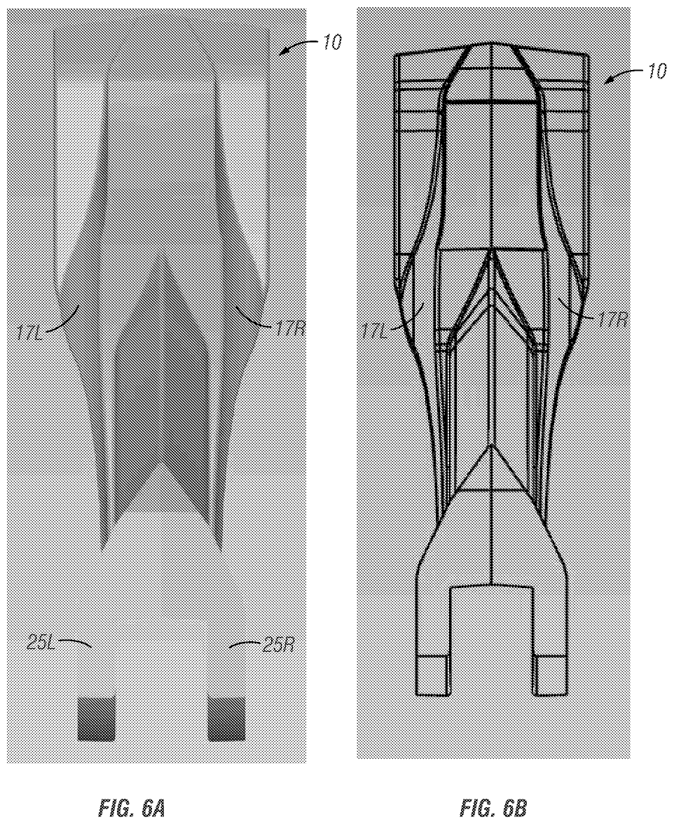

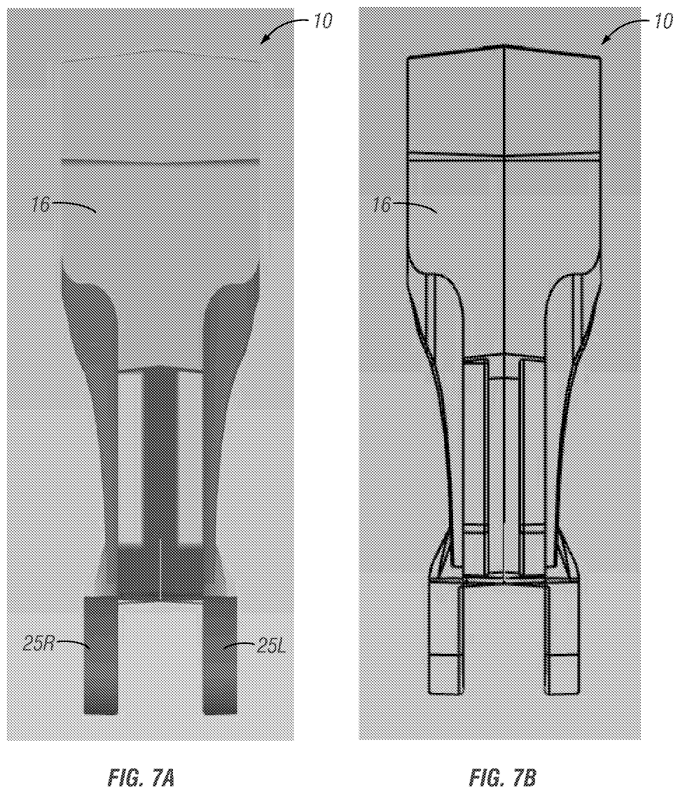

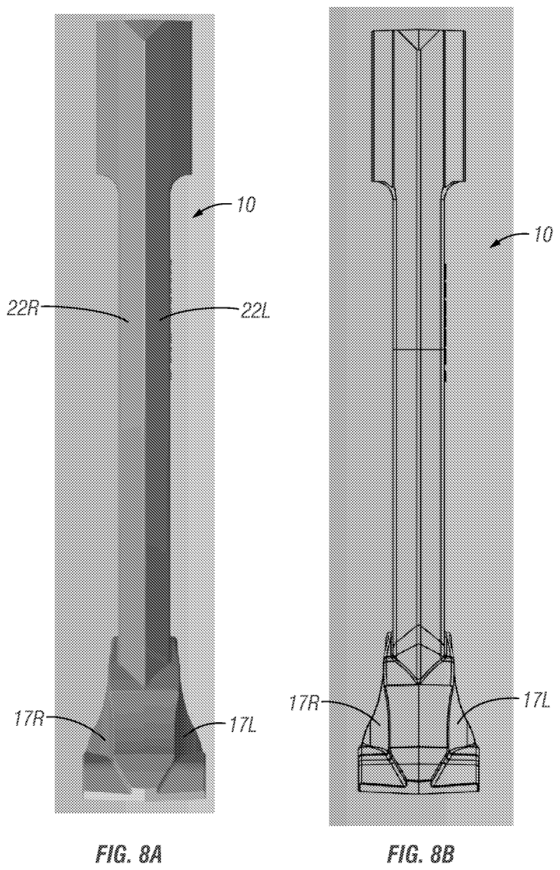

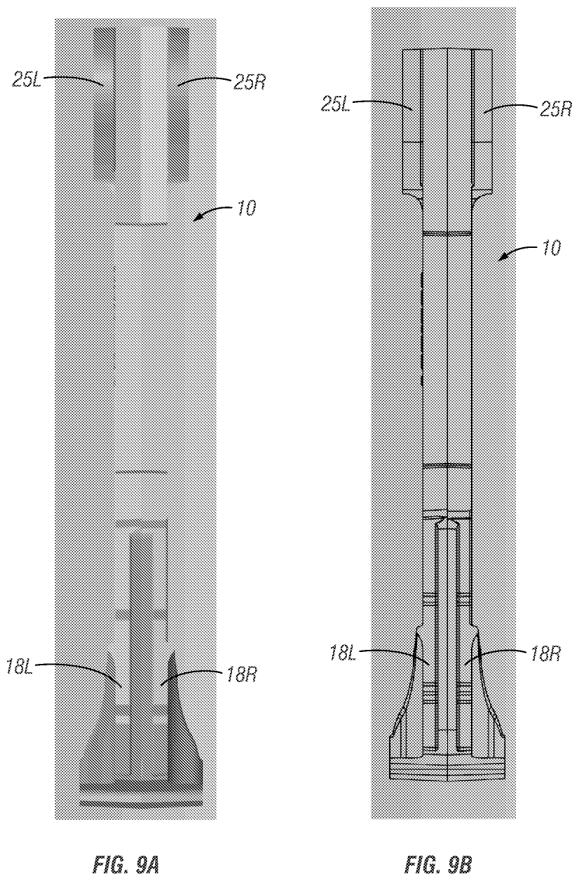

Another example is that side surfaces 17L and R can diverge or expand laterally relative the frontal plane XY front to back, at least a first distance. In the illustrated example of FIGS. 2-9, there is approximately an inch or so lateral expansion from nearest the leading edge of tip 13 to the widest lateral expansion. This can help surfaces 17L and R collect soil for rolling as tool 10 travels through the sub-soil. These characteristics are not necessarily required.

Another example is that side surfaces 17L and R can incline upwardly relative median plane YZ front to back of tool 10. In the illustrated example of FIGS. 2-9, there is approximately a 20 to 40 degree upward incline relative the median plane YZ front to back for surfaces 50L and R. This can also help collect and roll soil which is fed to surfaces 50L and R by leading edge and upper surface ramps on point 13. These characteristics are not necessarily required.

In the example of FIGS. 2-9, tool 10 is one-piece. It can be made of a variety of materials if of sufficient strength, rigidity, and robustness to resist deformation or breakage at the relatively high forces soil rippers can experience. One example is steel. Steel can be cast, machined, or otherwise formed to create angled steel to roll soil around shank with selected radii of curvature. Another example is ductile cast iron. It could be finished to coat and protect it. Other materials are possible that are sufficiently robust to take the mechanical stresses and forces of sub-soilers, including in minimum tillage applications.

As can be appreciated, the generalized example meets one or more of the aspects, features, advantages, or objects of the invention. Concaved side surfaces of the sub-soiler tip, effective to roll soil as tool 10 passes, produce one or more of the benefits according to the invention.

FIG. 10 roughly diagrammatically illustrates how an implement frame I (here showing just one tool bar of such a frame) could support a plurality of tools 10 at spaced apart locations that coincide at least generally to a desired row crop spacing. Adjustment of implement 1 could control depth of points 13 of tools 10A-C to a desired sub-soil layer S2. That layer S2 could be a desired seed bed depth. This typically could be from 1 to 11 inches beneath the soil surface, at least in many mid-west crop field soils.

Soil layer S1 is between the soil surface and the top of layer S2. This layer would be slit by the cutting edge of the shanks of tools 10A-C.

Soil layer S3 is intended to indicate the soil beneath layer S2, which is typically at least substantially undisturbed by movement of sub-soiler tips 13 though layer S2 and shanks 12 through layer S1. In correct orientation and depth, movement of implement 1 across the soil would move tips 13 through layer S2, break up hard pan or large sub-soil clods, roll soil with side surfaces SOL and R, but replace it aft of the tools' trailing ends in layer S2. The rolled soil would typically be of more uniform density than prior to working by tools 10A-C, remain in its original sub-soil depth, but deter air pockets or voids that can be detrimental to plant growth.

It is to be appreciated that tool 10 could be used for other purposes than preparing a sub-soil seed bed. For example, as diagrammatically illustrated in FIG. 10, another device or component could be mounted on or connected to the trailing end of a tool 10. One example is a mole body which might be used to intentionally form a tunnel or channel the diameter of the mole body 9 (see, e.g., FIG. 1E) and smooth or smear its side walls to deter collapse of the tunnel or channel. Another example would be a cable or tube laying system that feeds cable or tubing through or down the trailing side of a tool 10 and into a tunnel or channel formed by tool 10 or by a feature or mole. The size of tool 10 could be scaled up for larger cables or tubing. Other auxiliary components attached to tool 10 are possible.

### C. Specific Embodiment 1

With particular reference to FIGS. 11A-B to 17A-E, a specific exemplary embodiment according to one or more aspects of the invention will be shown and described in detail. It is to be understood that this embodiment 10′ is at least similar to the illustration of the generalized embodiment 10 above. Here, the specific features of the sub-soil point 13 will be discussed in more detail. FIGS. 16A-E give specific dimensional characteristics. As such, these details show how this specific embodiment can be made and used. FIGS. 17A-E diagrammatically illustrate soil movement as this embodiment 10′ is moved through the ground.

1. Leading Edge Section of the Point

FIGS. 11A-F focus on features of front or leading portion 30 of tool 10′. Dashed lines are used only to generally indicate the margins of different features. A leading edge 41 extends, with slight side to side rearward sweep, symmetrically and laterally of median plane YZ (along longitudinal axis 21 of tool 10′). The features of the left (L) (in the sense it is on the left side of tool 10′ when moving through soil) lateral side of leading cutting section 40 will be described now. It is to be understood that, in this embodiment, the same features are symmetrical on the opposite side.

Edge 41 has a relatively small generally vertical height (see surface 42L). This helps present a robust and durable leading cutting edge. Upper surface 44L nearer centerline 21 and upper surface 46L slightly stepped down at 45L and laterally from it, both are slightly inclined in the median YZ plane front to back and serve as ramps or lifters of soil. Surface 44L lifts soil further rearward and towards 47L and the vertical cutting edge along 21 at shank 12. Surface 44L lifts and guides soil to the soil-rolling sides. Leading section 40 has a somewhat greater height than following section (see flat side wall 43L).

As will be appreciated, both sides of leading section 40 extend laterally (width greater than the width of the shank). This is robust but also attacks and manipulates a substantial width of sub-soil and feeds it for further manipulation by following features of tool 10′.

2. Upper Medial Section

Front medial ramp 46L feeds soil to following medial ramp 52L of upper medial section 50, as shown in FIGS. 12A-F. Slightly concave in median plane YZ front to back, and further inclined front to back, ramp 52L feeds soil to following tapered portion 53L. Surfaces 52L and 53L have lateral widths relative the lateral or transverse XZ plane. Soil is either slightly lifted and guided back and around vertical edge 21 of shank 12, or some soil at least at or near the lateral edge of surface 52L may be guided towards or move into the soil rolling side surfaces.

Ramp surface 46L of leading section 40 feeds soil to both a soil-rolling side feature (discussed below) and an upper surface 54L (see FIG. 12A). Together, surfaces 46L and 54L help feed the soil-rolling feature.

FIG. 12C shows how bottom surface 56L is stepped up at 55L from leading section 40, and then narrows back towards median plane YZ (or longitudinal axis 21) towards the back of tool 10′. This promotes rolled soil to fill back in at its native level in the wake of tool 10′.

3. Bottom

FIGS. 13A-C give additional information about the bottom 60 of tool 10′. As mentioned, it steps up between surfaces 47L and 56L. Surface 56L narrows front to back.

Symmetrical flanges 18L and R at the back of tool 10′ are relatively narrow with relative flat sides relative median plane YZ. Because they are laterally narrower than preceding side surfaces of sections 40 and 50, this promotes rolled soil to fill in the wake of tool 10′ and they would deter any smearing or compacting of the rolled soil.

4. Soil Rolling Section

FIGS. 14A-F give additional illustration of soil rolling features 70 of tool 10′. In this example, surface 72L of feature 70 has the following characteristics:
a. defined by a base line 73 along the medial side of surface 54L, and then two converging, front to back, top 74 and bottom 75 margins, terminating in a small rear margin 76 (see dashed lines in FIG. 14A).
b. surface 72L tapers front-to-back from margin 73 to margin 76.
c. There is a radius between top and bottom margins 74 and 75 along a general centerline 77 of surface 72 (shown diagrammatical with dashed curved lines lateral across center line 77 in FIG. 14A).
d. Surface 72L diverges laterally front to back between margins 74 and 75 (see FIG. 14D).
e. Surface 72L center line 77 is inclined front to back relative to front section 40.

This combination of features works to promote rolling of soil as tool 10′ moves through the ground. Soil is fed to surface 72L. Because it extends laterally (FIG. 14D), it is exposed to both soil being fed to it and to other soil it encounters. The radiuses and tapering and incline front to back promote the rolling action. And these features then promote dropping, depositing, or placing the rolled soil in the wake of tool 10′. It would basically roll over margin 75 and replace the space taken by point 13 with the help of the narrowing of tool 10′ at its back section.

5. Further Details

FIGS. 15A-I are diagrammatic sectional depictions to help understand the specific shape of the foregoing surfaces of tool 10′. As will be appreciated, tool 10′ can be cast as a solid. FIGS. 15A-1 are intended to help show surface shapes with diagrammatical depictions of both exterior surfaces and edges, and sometimes interior surfaces and edges.

FIGS. 16A-E are dimensioned to also help understand the features of tool 10′

FIGS. 17A-E diagrammatically roughly depict how tool 10′ manipulates sub-soil as it moves through it, in particular how side surfaces 72L or R roll soil and drop/place it in the wake of tool 10′.

### D. Specific Embodiment 2

With particular reference to FIGS. 18A-G, another specific exemplary embodiment according to one or more aspects of the invention will be shown and described in detail. It is to be understood that this embodiment 10″ has similarities to the first specific embodiment 10′ but also has differences as discussed below. FIGS. 18A-G give specific dimensional characteristics of second specific embodiment 10″. As will be appreciated embodiment 10″ has side soil-rolling features 70L″ and 70R″. They promote rolling of soil similar to shown in FIGS. 17A-E for first specific embodiment 10′.

In this example, each symmetrical soil rolling side feature 70″ has the following characteristics:
a. defined by two generally parallel, front to back, top 74″ and bottom 75″ margins (see FIG. 18A).
b. two surfaces 72F″ (front) and 72B″ (back) follow one another front-to-back of tool 10″.
c. There is a radius between top and bottom margins 74″ and 75″ along a general centerline of surfaces 72F″ and 72B″.
d. Surface 72F″ diverges laterally outward front to back (see FIG. 18D) but then surface 72B″ extends generally straight back to termination.

This combination of features works to promote rolling of soil as tool 10″ moves through the ground. Soil is fed from leading and upper sections of the point to surface 72F″ (like the first specific embodiment). Because surface 72F″ extends laterally (FIG. 18D), it is exposed to both soil being fed to it and to other soil it encounters. The radius between top and bottom margins 74″ and 75″ front to back promotes the rolling action. It is akin to a snow plow blade. Soil enters the concave, radius surface 72F″ and its shape and angle of attack rolls soil along its surface front to rear. Then rear surface 72B″ receives it and guides it to fill in the wake of tool 10″. These features then promote dropping, depositing, or placing the rolled soil in the wake of tool 10″. It would basically roll out the back of surface 72B″ and replace the space taken by point 13″ with the help of the narrowing of tool 10″ at its back section.

The rolling of soil with tool 10″ would be similar to tool 10′, and as diagrammatically illustrated at FIGS. 17A-E.

FIGS. 19A and B are similar to FIGS. 17A-E but for tool 15.

### E. Options and Alternatives

The foregoing embodiments are exemplary only. Variations are possible, including those obvious to those skilled in the art. Some of the variations are mentioned above. Additional examples follow.

1. Size and Scale

As mentioned, the drawings give examples only. Size, form factors, proportions can vary according to desire or need. Tool 10, 10′, or 10″ can be scaled up or down according to need.

2. Materials

As mentioned, robust materials such as steel and iron can be used. Others may be possible if they provide reasonable useful life in the context of application.

3. Applications

As mentioned, strip tillage is one application, whether minimum tillage or otherwise. However, other applications are possible. For example, there may be need for a single tool 10, 10′, or 10″, or a variation therefore (including scaled up or down) to manipulate sub-soil. It may simply be used to break up soil. By further example, another component or device could be attached to the back of the tool and the combination of the tool and the other device be used. One example is illustrated in FIG. 1E. Tool 10 or a variation could slit the ground, condition the soil, but then the following device could further manipulate the soil.

What is claimed is:

1. A ground-working tool comprising:
a. a shank having a longitudinal axis between a top end and a bottom end;
b. a sub-soil point at the bottom end of the shank, the sub-soil point having a leading cutting edge transverse to and in front of the longitudinal axis of the shank, a back portion behind the shank, a top portion from the leading edge to the shank, a bottom portion, and opposite lateral sides; and
c. a soil-rolling surface on at least one of the opposite lateral sides of the sub-soil point, each soil-rolling surface;
i. being concave in cross-section between top and bottom edges along a front to back length;
ii. having a forward section diverging laterally from the longitudinal axis of the shank;
d. such that the leading cutting edge of the sub-soil point promotes break up of hard pan and clods, and promotes rolling of soil at and near the soil-rolling surfaces for a more uniform density conditioned soil at that sub-soil level.

2. The tool of claim 1 wherein the concave in cross-section comprises a radius.

3. The tool of claim 2 wherein the radius decreases from front to back of the surface.

4. The tool of claim 1 wherein the top and bottom edges of the surface incline from the leading edge front to rear.

5. The tool of claim 1 wherein the top and bottom edges of the surface converge or taper front to rear.

6. The tool of claim 1 wherein the soil-rolling surface further comprises a rearward section that diverges less than the front section.

7. The tool of claim 1 wherein the shank further comprises a leading cutting edge, soil rolling surfaces on both lateral sides, and the soil rolling surfaces are generally symmetrical.

8. The tool of claim 1 wherein the top portion of the sub-soil point comprises one or more upwardly and rearwardly angled ramps or surfaces.

9. A combination of one or more of the tool of claim 1 mounted to an implement frame adapted from movement soil and including a height adjustment to adjust subsoil depth of the sub-soil point of the tool for the ground.

10. The combination of claim 9 wherein the implement comprises a minimum tillage soil tiller.

11. A sub-spoiler ground working tool comprising:
a. a shank elongated along a longitudinal axis between an upper end and a lower end, the shank having a median plane generally along the longitudinal axis;
b. a shoe at the lower end of the shank, the shoe comprising:
i. a body having a lower portion and an upper portion;
ii. the lower portion comprising a plate having a front, back, top, bottom and opposite sides generally in a transverse plane relative the median plane, the front including a transverse leading edge;
iii. the upper portion comprising:
1. a top medial surface extending upward from the transverse leading edge to the shank; and
2. generally symmetrical side surfaces on opposite sides of the top medial surface, each side surface being generally concave along its length and extending between towards the transverse leading edge and rearward towards the shank relative a frontal plane for each side surface orthogonal to the median and transverse planes.

12. The tool of claim 11 wherein each side surface is tapered front to rear in its respective frontal plane.

13. The tool of claim 11 wherein each side surface extends generally parallel to the plate in its respective frontal plane.

14. The tool of claim 11 wherein are each side surface is inclined front to rear relative to the plate in its respective frontal plane.

15. The tool of claim 11 wherein each side surface has a top margin and a bottom margin front to rear in its respective frontal side.

16. The tool of claim 15 wherein the top and bottom margins are generally linear.

17. The tool of claim 15 wherein the top and bottom margins are generally curvilinear.

18. The tool of claim 11 wherein the concave comprises a radius transverse of the side surface.

19. The tool of claim 18 wherein the radius is constant front to back of the side surface.

20. The tool of claim 18 wherein the radius decreases front to back of the side surface.

21. A method of tilling soil comprising:
a. submerging a sub-soil point with a leading cutting edge to a desired depth in the soil;
b. moving the sub-soil point through the sub-soil at the desired depth effective to break up hard pan while rotating soil with side features of the sub-soil point effective to promote a more uniform density of sub-soil at the desired depth.

22. The method of claim 21 wherein the subsoil point is at the lower end of a shank depending from a frame of an implement that is moved over the soil by an automotive vehicle.

23. The method of claim 22 wherein the subsoil point comprises a plate-like shoe having a transverse width, a front to back length, and a top to bottom thickness, and the leading cutting edge at the transverse width of the sub-soil point and the side features are built into the sub-soil point.

24. The method of claim 23 wherein the side features front to back are generally concave with a radius between top and bottom margins effective to roll soil at or near the side features.

25. The method of claim 24 wherein the top and bottom margins converge front to back.

26. The method of claim 21 wherein the side features diverge laterally from the leading edge rearwardly at least part of the front to rear length of the sub-soil point.

27. The method of claim 21 further comprising a plurality of said sub-soil points spaced laterally apart.

28. The method of claim 27 applied to minimum tillage soil conditioning.
